(19) United States
(12) Patent Application Publication
(10) Pub. No.: US 2026/0246607 A1
(43) Pub. Date: Aug. 20, 2026

(54) SERVER APPARATUS FOR PROCESSING HOMOMORPHIC ENCRYPTED MESSAGES AND METHODS THEREOF

(71) Applicant: CRYPTO LAB INC., Seoul (KR)

(72) Inventors: Guillaume Hanrot, Seoul (KR); Seonhong Min, Seoul (KR); Damien Stehle, Seoul (KR)

(21) Appl. No.: 19/539,789

(22) Filed: Feb. 13, 2026

(30) Foreign Application Priority Data
Feb. 14, 2025 (KR) 10-2025-0019162
Jan. 23, 2026 (KR) 10-2026-0014043

(51) Int. Cl. H04L 9/00

(52) U.S. Cl. CPC H04L 9/008

(57) ABSTRACT

A server apparatus is disclosed. The server apparatus receives, from an electronic apparatus that converts a plaintext message into a homomorphic ciphertext by using a sparse secret key and a public key having a size equal to or less than a predetermined size, and stores a first public key, a second public key, and homomorphic ciphertexts, and performs a bootstrapping operation by generating a plurality of partial ciphertexts based on valid terms corresponding to valid data positions in the sparse secret key by using the first public key and the second public key, and combining the plurality of partial ciphertexts through a parallel binary product tree and then performing matrix multiplication.

### CROSS-REFERENCE TO RELATED APPLICATION(S)

This application claims benefit of priority to Korean Patent Application No. 10-2025-0019162 filed on Feb. 14, 2025 in the Korean Intellectual Property Office and Korean Patent Application No. 10-2026-0014043 filed on Jan. 23, 2026 in the Korean Intellectual Property Office, the disclosures of which are incorporated herein by reference in its entirety.

### BACKGROUND

### Field

Apparatuses and methods consistent with the disclosure relate to a server apparatus for processing a homomorphic ciphertext and a method thereof.

### Description of Related Art

As communication technology is developed and electronic apparatuses become more widespread, efforts to maintain communication security between electronic apparatuses are continuously being made. Accordingly, encryption/decryption technologies are used in most communication environments.

As one of the encryption technologies, homomorphic encryption methods have recently been researched. According to homomorphic encryption, even when the ciphertext itself is evaluated without decrypting encrypted information, the same result as encryption values after evaluating the plaintext may be obtained. Therefore, various operations may be performed without decrypting the ciphertext.

However, when various operations such as multiplication are performed on a homomorphic ciphertext, plaintext spaces in the homomorphic ciphertext are reduced. Accordingly, when the plaintext spaces are reduced to below a certain size, no further operation is possible. In this case, bootstrapping for expanding a plaintext space of the homomorphic ciphertext may be performed. Therefore, the need for efficient bootstrapping methods with respect to homomorphic ciphertexts has emerged.

### SUMMARY

Provided are a server apparatus for efficiently processing bootstrapping of a homomorphic ciphertext and a method thereof.

In accordance with an aspect of the disclosure, a server apparatus includes a communication interface, a memory, and a processor, wherein the processor is configured to receive, from at least one electronic apparatus that converts a plaintext message into a homomorphic ciphertext by using a sparse secret key and a public key having a size equal to or less than a predetermined size, a first public key for performing a column method to identify candidate indices corresponding to valid data positions in the sparse secret key, a second public key for a blind rotation operation to select indices corresponding to the valid data positions among the candidate indices identified by the column method, and the homomorphic ciphertext, and store the first public key, the second public key, and the homomorphic ciphertext in the memory, and based on a modulus level of at least one homomorphic ciphertext stored the memory falling to a predetermined threshold level or lower, perform a bootstrapping operation to reset the modulus level of the at least one homomorphic ciphertext, by generating a plurality of partial ciphertexts based on valid terms corresponding to the valid data positions in the sparse secret key by using the first public key and the second public key with respect to the at least one homomorphic ciphertext, and combining the plurality of partial ciphertexts through a parallel binary product tree and then performing matrix multiplication.

In accordance with an aspect of the disclosure, a method of processing homomorphic ciphertexts of a server apparatus includes receiving, from at least one electronic apparatus that converts a plaintext message into a homomorphic ciphertext by using a sparse secret key and a public key having a size equal to or less than a predetermined size, a first public key for performing a column method to identify candidate indices corresponding to valid data positions in the sparse secret key, a second public key for a blind rotation operation to select indices corresponding to the valid data positions among the candidate indices identified by the column method, and the homomorphic ciphertext, and storing the first public key, the second public key, and the homomorphic ciphertext, and based on a modulus level of at least one homomorphic ciphertext stored in the memory falling to a predetermined threshold level or lower, performing a bootstrapping operation to reset the modulus level of the at least one homomorphic ciphertext, wherein the performing of the bootstrapping operation includes generating a plurality of partial ciphertexts based on terms corresponding to the valid data positions in the sparse secret key by using the first public key and the second public key with respect to the at least one homomorphic ciphertext, and combining the plurality of partial ciphertexts through a parallel binary product tree and then performing matrix multiplication.

According to various embodiments of the present disclosure as described above, efficient processing is possible by reducing the time required for bootstrapping or the computational burden.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a diagram for explaining an operation of a server apparatus according to at least one embodiment of the present disclosure.

FIG. 2 is a block diagram illustrating a configuration of a server apparatus and an electronic apparatus according to at least one embodiment of the present disclosure.

FIG. 3 is a flowchart illustrating a method of processing a homomorphic ciphertext of a server apparatus according to at least one embodiment of the present disclosure.

FIG. 4 is a flowchart illustrating a bootstrapping processing method of a server apparatus according to at least one embodiment of the present disclosure.

FIG. 5 is a flowchart illustrating a method of performing bootstrapping by lowering a tree level in a server apparatus according to at least one embodiment of the present disclosure.

FIG. 6 is a flowchart illustrating a method of performing bootstrapping on a plurality of homomorphic ciphertexts having an identical mask in a server apparatus according to at least one embodiment of the present disclosure.

### DETAILED DESCRIPTION

Hereinafter, embodiments are described in detail with reference to the accompanying drawings. Encryption/decryption may be applied to an information (data) transmission process performed in the present disclosure as necessary, and all expressions describing the information (data) transmission process in the present disclosure and claims should be interpreted as including cases where encryption/decryption is applied even if not specifically mentioned. In the present disclosure, expressions such as “transmitting (transferring) from A to B” or “A receiving from B” include transmitting (transferring) or receiving via an intermediate medium, and do not necessarily express only directly transmitting (transferring) or receiving from A to B.

In the description of the present disclosure, the order of the steps should be understood as non-limiting unless a preceding step should logically and temporally precede a subsequent step. That is, except for such exceptional cases as described above, even if a process described in the subsequent step is performed before a process described in the preceding step, it does not affect the essence of the disclosure, and the scope of rights should be defined regardless of the order of the steps. Also, the term “A or B” as used herein is defined to mean not only the selective reference to either A or B, but also the inclusion of both A and B. In addition, the term “including” as used in the present disclosure encompasses the inclusion of additional components beyond those listed as included.

In the present disclosure, only essential components necessary for the description of the present disclosure are described, and components that are not related to the essence of the present disclosure are not mentioned. Also, it should not be interpreted in an exclusive sense as including only the mentioned components, but rather in a non-exclusive sense that may also include other components.

Also, the term “value” as used in the present disclosure is defined as a concept encompassing not only scalar values but also vectors.

The mathematical operation and calculation of each step of the present disclosure described below may be implemented as computer operations by coding methods known for performing the corresponding operation or calculation and/or coding suitably designed for the present disclosure.

The specific mathematical formulas described below are exemplarily explained among several possible alternatives, and should not be interpreted as limiting the scope of the present disclosure to the mathematical formulas mentioned in the present disclosure.

For the convenience of explanation, the following notations are adopted in the present disclosure.
a←D: an element a is selected according to a distribution D
s1, s2∈R: s1 and s2 are elements belonging to a set R
mod(q): a modular operation with a q element
└⋅┐: an internal value is rounded

Hereinafter, various embodiments of the present disclosure will be described in detail with reference to the accompanying drawings.

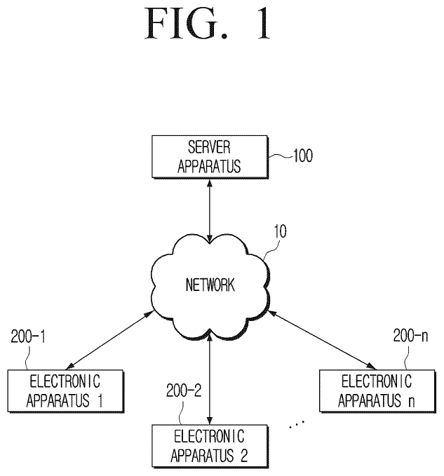

FIG. 1 is a diagram for explaining an operation of a server apparatus according to at least one embodiment of the present disclosure. According to FIG. 1, a server apparatus 100 and a plurality of electronic apparatuses 200-1 to 200-n may be connected to each other through a network 10.

The network 10 may be implemented as various types of wired and wireless communication networks, broadcast communication networks, optical communication networks, cloud networks, etc. In FIG. 1, the apparatuses 100 and 200-1 to 200-n are indirectly connected to each other through the network 10, but are not limited thereto, and may be connected in a manner such as Wi-Fi, Bluetooth, and near field communication (NFC), etc. without a separate medium.

In FIG. 1, the server apparatus 100 is an apparatus for performing various processes such as storing a homomorphic ciphertext and evaluating the homomorphic ciphertext. The server apparatus 100 may be implemented as a single electronic apparatus or may be implemented as a cloud server. In addition, the server apparatus 100 may be implemented as a web server accessible through the Internet, etc.

In FIG. 1, the server apparatus 100 is described to distinguish from the electronic apparatuses 200-1 to 200-n, but the server apparatus 100 may also be described as an electronic apparatus, and in this case, the other electronic apparatuses 200-1 to 200-n may be described as external apparatuses.

The electronic apparatuses 200-1 to 200-n may be various terminal apparatuses used by various users. Specifically, the electronic apparatuses 200-1 to 200-n may be implemented in various forms such as PCs, laptop PCs, smartphones, tablet PCs, game players, home servers, kiosks, etc. In addition, the electronic apparatuses 200-1 to 200-n may be implemented in the form of home appliances to which IoT functions are applied, or may be other server apparatuses.

The electronic apparatuses 200-1 to 200-n may generate various keys related to processing of the homomorphic ciphertext, convert a plaintext message into the homomorphic ciphertext by using the keys, and then transmit the homomorphic ciphertext and some keys to the server apparatus 100. The keys related to processing of the homomorphic ciphertext may include a public key, a secret key, an operation key, a switching key, etc.

The users may input various information through the electronic apparatuses 200-1 to 200-n used by the users. The input information may be stored in the electronic apparatuses 200-1 to 200-n themselves, but may be transmitted to and stored in an external apparatus, for example, the server apparatus 100 of FIG. 1, for reasons such as storage capacity and security. In a process of transmitting the information to the external apparatus, data may be leaked to a third party, or an administrator of the external apparatus may directly check the corresponding data content or leak the data content to the outside. Therefore, in the case of data that require security, such as user's personal information, it is necessary to encrypt and convert the data to prevent a third party from checking the data, and then provide the data to an external apparatus.

However, in the case of a general ciphertext, because operations are impossible in an encrypted state, it is impossible for the server apparatus 100 storing the ciphertext to extract meaningful information by using the corresponding ciphertext.

Accordingly, homomorphic encryption technology has been developed. That is, each of the electronic apparatuses 200-1 to 200-n may convert a plaintext message into a homomorphic ciphertext through homomorphic encryption, and then transmit the homomorphic ciphertext itself to the server apparatus 100. The server apparatus 100 may store the homomorphic ciphertext as it is, when an operation is required, perform the operation as it is in a homomorphic ciphertext state, and transmit a result of the operation to a party requesting the operation. For example, when the user of the first electronic apparatus 200-1 of FIG. 1 requests a result of an operation, the server apparatus 100 transmits the result of the operation performed in the homomorphic ciphertext state to the first electronic apparatus 200-1. The first electronic apparatus 200-1 may decrypt the result of the operation by using a secret key and provide the result of the operation to the user in the form of a plaintext.

Each of the electronic apparatuses 200-1 to 200-n may include encryption noise calculated in a process of performing homomorphic encryption, that is, an error, in the homomorphic ciphertext. Specifically, a homomorphic ciphertext generated by each of the electronic apparatuses 200-1 to 200-n may be generated in a form that allows a result value including a message and an error value to be restored when subsequently decrypted using a secret key.

For example, the homomorphic ciphertexts generated by the electronic apparatuses 200-1 to 200-n may be generated in a form that satisfies the following properties when decrypted using the secret key.

$$Dec ( ct , sk ) = 〈 ct , sk 〉 = M + e ( mod q ) \qquad [ Mathematical Formula 1 ]$$

Here, <, > denote a usual inner product, ct denotes a ciphertext, sk denotes a secret key, M denotes a plaintext message, e denotes an encryption error value, and mod q denotes a modulus of the ciphertext. q must be selected to be greater than a result value obtained by multiplying a message by a scaling factor (Δ). If the absolute value of the error value e is sufficiently small compared to M, a decryption value M+e of the ciphertext is a value that may replace the original message with the same precision in a significant figure operation. In the decrypted data, an error may be placed on a least significant bit (LSB) side, and M may be placed on a next LSB side.

When the size of a message is too small or too large, each of the electronic apparatuses 200-1 to 200-n may adjust the size thereof by using a scaling factor. When the scaling factor is used, not only a message in the form of integers but also a message in the form of real numbers may be encrypted, and thus utilization may be greatly increased. In addition, by adjusting the size of the message by using the scaling factor, the size of an area where messages exist in the ciphertext after the operation is performed, that is, a valid area, may be adjusted.

According to an embodiment, the ciphertext modulus q may be set and used in various forms. For example, a modulus of the ciphertext may be set in the form of an exponential power q=Δ^{L} of the scaling factor Δ. When Δ is 2, the modulus of the ciphertext may be set to a value such as q=2¹⁰.

Also, the homomorphic ciphertext according to the present disclosure is explained on the assumption that a fixed point is used, but it may also be applied when a floating point is used.

The server apparatus 100 may store the homomorphic ciphertexts transmitted from the electronic apparatuses 200-1 to 200-n. In this state, when there is a user request or a specific event occurs, the server apparatus 100 may perform operations on the stored homomorphic ciphertexts. In this case, the proportion of an approximate message within the ciphertext varies as a result of the operation obtained for each operation. Accordingly, when the proportion of the approximate message exceeds a threshold, no further operation is possible on the corresponding homomorphic ciphertext. The proportion of the approximate message exceeding the threshold may mean that a modulus level of the corresponding homomorphic ciphertext is reduced and falls to a predetermined threshold level or lower.

When the proportion of the approximate message exceeds the threshold, the server apparatus 100 may perform a bootstrapping operation. Bootstrapping may be a task of resetting a modulus level of at least one homomorphic ciphertext.

Specifically, when q is less than M in the mathematical formula 1 described above, M+e(mod q) has a value different from that of M+e, and thus, decryption becomes impossible. Therefore, the q value needs to always remain greater than M. However, the q value gradually decreases as the operation proceeds. Therefore, an operation of changing the q value to always be greater than M is required, and this operation is called a bootstrapping operation. As the bootstrapping operation is performed, the corresponding homomorphic ciphertext may be a state where an operation can be performed again.

However, in the case of conventional homomorphic encryption technology, there was a problem that the amount of computation to perform bootstrapping was so large that considerable time and resources were consumed.

According to various embodiments of the present disclosure, the server apparatus may use a public key having a size equal to or less than a predetermined size while performing bootstrapping in a sparse homomorphic indexing procedure (SHIP) method using a sparse secret key, which significantly reduces the number of rotations and selection operations compared to the existing bootstrapping method, thereby more efficiently performing bootstrapping.

Specifically, the electronic apparatus may convert a plaintext message into a homomorphic ciphertext by using a sparse secret key and a public key having a size equal to or less than a predetermined size and transmit the homomorphic ciphertext to the server apparatus. The public key may include a first public key for performing a column method to identify candidate indices corresponding to valid data positions in the sparse secret key, and a second public key for a blind rotation operation to select indices corresponding to the valid data positions among the candidate indices identified by the column method. The server apparatus may store the received first and second public keys and the homomorphic ciphertexts to perform various operations. When a homomorphic ciphertext is used for more than a certain number of operations and a modulus level thereof falls to a predetermined threshold level or lower, the server apparatus may generate a plurality of partial ciphertexts with respect to the corresponding homomorphic ciphertext based on valid terms corresponding to the valid data positions in the sparse secret key by using the first public key and the second public key, and performing a bootstrapping operation of resetting the modulus level of the homomorphic ciphertext by combining the plurality of partial ciphertexts through a parallel binary product tree, and performing matrix multiplication.

Hereinafter, various embodiments for efficiently performing the SHIP method bootstrapping using the sparse secret key will be described in detail.

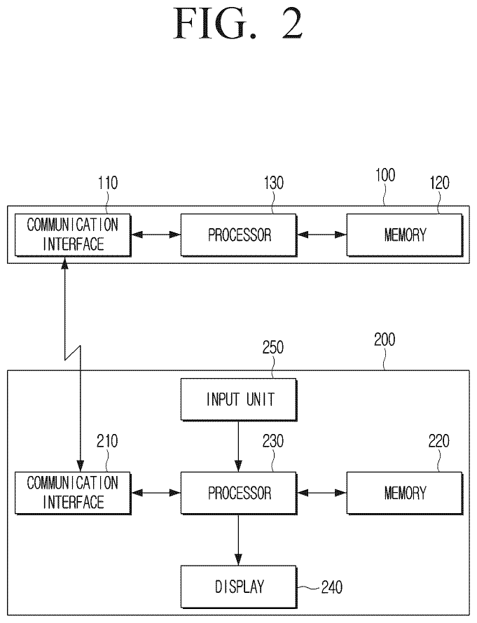

FIG. 2 is a block diagram illustrating a configuration of a server apparatus and an electronic apparatus according to at least one embodiment of the present disclosure. An electronic apparatus 200 of FIG. 2 may be one of the plurality of electronic apparatuses 200-1 to 200-n of FIG. 1.

Referring to FIG. 2, the server apparatus 100 includes a communication interface 110, memory 120, and a processor 130.

The communication interface 110 is a component for performing communication with various external apparatuses including the electronic apparatus 200.

The communication interface 110 may transmit and receive various signals and data to and from an external apparatus through various wired and wireless communication methods such as wired/wireless Local Area Network (LAN), Wide Area Network (WAN), Ethernet, IEEE 1394, Bluetooth, AP-based Wi-Fi (Wi-Fi, Wireless LAN Network), Zigbee, High-Definition Multimedia Interface (HDMI), Universal Serial Bus (USB), Mobile High-Definition Link (MHL), Audio Engineering Society/European Broadcasting Union (AES/EBU), Optical, Coaxial, etc. For example, the communication interface 110 may receive a homomorphic ciphertext, various keys, and an operation request from each of the electronic apparatuses 200-1 to 200-n of FIG. 1, and may transmit a result of an operation performed on the homomorphic ciphertext to each of the electronic apparatuses 200-1 to 200-n.

The memory 120 is a component storing various programs, data, and instructions necessary for an operation of the server apparatus 100. The memory 120 may be implemented with at least one of various memories such as dynamic RAM (DRAM), static RAM (SRAM), synchronous dynamic RAM (SDRAM), one time programmable ROM (OTPROM), programmable ROM (PROM), erasable and programmable ROM (EPROM), electronically erasable and programmable ROM (EEPROM), mask ROM, flash ROM, flash memory, hard drive, or solid state drive (SSD).

The memory 120 may store various homomorphic ciphertexts received through the communication interface 110 or an operation key, a switching key, a public key, etc. for use in operations of the homomorphic ciphertexts. In addition, the memory 120 may store various mathematical formulas and instructions necessary to perform bootstrapping in a SHIP method using a sparse secret key and a public key having a size equal to or less than a predetermined size. As described above, the first public key and the second public key transmitted from the electronic apparatus, and the homomorphic ciphertext may be stored in the memory 120. Alternatively, the memory 120 may store at least one artificial intelligence (AI) model capable of processing a homomorphic ciphertext, data and program for training the AI model.

The processor 130 is a component for controlling the overall operation of the server apparatus 100. The processor 130 may perform various operations based on instructions, programs, and data stored in the memory 120.

The processor 130 may be implemented as a digital signal processor (DSP) or a microprocessor that processes digital signals. However, the processor 130 is not limited thereto, and may include, or be defined as, one or more of a central processing unit (CPU), a micro controller unit (MCU), a micro processing unit (MPU), a controller, an application processor (AP), or a communication processor (CP), an ARM processor, a graphics processing unit (GPU), a neural processing unit (NPU), and an AI processor. In addition, the processor 130 may be implemented as a System on Chip (SoC) and a large scale integration (LSI) with embedded processing algorithms, or may be implemented in the form of a field programmable gate array (FPGA).

The CPU is a general-purpose processor capable of performing not only general operations but also AI operations, and may efficiently execute complex programs through a multi-layered cache structure. The CPU is advantageous for a serial processing method that enables organic linkage between a previous evaluation result and a next evaluation result through sequential evaluation.

The GPU is a processor for mass operations such as floating point operations used for graphic processing, and may perform large-scale operations in parallel by integrating cores in large quantities. In particular, the GPU may be more advantageous in a parallel processing method such as a convolution operation than the CPU. In addition, the GPU may be used as a co-processor for supplementing a function of the CPU.

The NPU is a processor specialized in AI operations using an artificial neural network, and each layer constituting the artificial neural network may be implemented as hardware (e.g., silicon). At this time, because the NPU is specialized and designed according to the specifications of a company, the NPU has a lower degree of freedom than the CPU or the GPU, but may efficiently process AI operations required by the company. On the other hand, as a processor specialized in AI operations, the NPU may be implemented in various forms such as a Tensor Processing Unit (TPU), an Intelligence Processing Unit (IPU), and a Vision Processing Unit (VPU). The AI processor is not limited to the above-described example except for the case specified as the above-described NPU.

In addition, the processor 130 may be implemented as a SoC. In this case, not only the one or more processors 130 but also the memory 120 may be mounted on the SoC, or a bus for data communication between the memory 120 and the processors 130 may be provided in the SoC.

When an operation request is received from the electronic apparatus 200 through the communication interface 110 or a preset event arrives, the processor 130 may perform an operation on at least one homomorphic ciphertext stored in the memory 120 and provide a result of the operation to the electronic apparatus 200 in a homomorphic encrypted form. The preset event may be various, such as a case in which a preset time period arrives, a new homomorphic ciphertext is received and stored, and an update to an existing stored homomorphic ciphertext is performed. For example, when a user transmits a homomorphic ciphertext with respect to personal information and requests to check whether the personal information is registered, the processor 130 may perform usual inner product operations between pre-stored homomorphic ciphertexts and the received homomorphic ciphertext, and then collect results of operations and transmit the results of operations to the electronic apparatus 200. In addition, types of operations on the homomorphic ciphertext may be variously changed according to a user's request.

When the results of operations are transmitted to the electronic apparatus 200, the electronic apparatus 200 may decrypt the results of operations and provide the results of operations to the user. The electronic apparatus 200 may be implemented in various types.

For example, when the electronic apparatus 200 is implemented as an apparatus in which a display is integrated, such as a smart phone or a tablet PC, the electronic apparatus 200 may include a configuration such as a communication interface 210, memory 220, a processor 230, a display 240, and an input unit 250 as shown in FIG. 2.

General operations and examples of the communication interface 210, the memory 220, and the processor 230 are the same as or similar to those described with respect to the server apparatus 100, and thus, redundant descriptions thereof are omitted.

The display 240 is a component for displaying various user interface (UI) screens. As described above, when the results of operations with respect to the homomorphic ciphertext transmitted by the server apparatus 100 is received through the communication interface 210, the processor 230 may decrypt the results of operations by using a secret key stored in the memory 220 and then display the results of operations on the display 240.

The input unit 250 is a component for inputting various user commands. When the electronic apparatus 200 is implemented as a smartphone or a tablet PC, the input unit 250 may be implemented as a touch screen integrated with the display 240. However, the input unit 250 is not limited thereto, and may be implemented as a button or a touch pad. Alternatively, in the case of the electronic apparatus 200 capable of voice recognition, the input unit 250 may include a microphone.

When the user inputs a user command requesting to store specific information in the server apparatus 100 through the input unit 250, the processor 230 may perform homomorphic encryption on the corresponding information.

The homomorphic encryption method may be implemented in various schemes. Various embodiments of the present disclosure are described with respect to a case of performing homomorphic encryption according to the Cheon-Kim-Kim-Song (CKKS) scheme is described, but the present disclosure is not limited thereto, and may also be implemented in various other schemes.

Various keys such as a public key and a secret key are required to perform homomorphic encryption. The processor 230 may directly generate these keys, or may receive and use the keys from an external apparatus.

When the electronic apparatus 200 generates a key by itself, the processor 230 may generate a public key by using the ring-LWE technique. Specifically, the processor 230 may first set various parameters and rings and store the various parameters and rings in the memory 220. Examples of parameters may include the length of a plaintext message bit, sizes of a public key and a secret key, etc.

The rings may be expressed in the following mathematical formula.

$$R = {ℤ}_{q} [ x ] / ( f ( x ) ) \qquad [ Mathematical Formula 2 ]$$

Here, R denotes a ring, Zq denotes a coefficient, and f(x) denotes an n-th polynomial.

The ring is a set of polynomials with a preset coefficient, the set defining addition and multiplication between elements and closed with respect to addition and multiplication.

For example, the ring refers to a set of n-th polynomials with the coefficient Zq. Specifically, when n is an Φ(N), the ring refers to an N-th cyclotomic polynomial (f(x)) denotes the ideal of Zq[x] generated by f(x). The Euler totient function Φ(N) denotes the number of natural numbers that are coprime to N and less than N. When Φ_{N}(x) is defined as the N-th cyclotomic polynomial, the ring may also be expressed in mathematical formula 3 as follows.

$$R = {ℤ}_{q} [ x ] / ( {Φ}_{N} ( x ) ) \qquad [ Mathematical Formula 3 ]$$

The ring of mathematical formula 3 described above has a complex number in a plaintext space.

To improve an operation speed with respect to the homomorphic ciphertext, only a set in which the plaintext space is a real number may be used among the above-described sets of rings.

When such a ring is set, the processor 230 may calculate a secret key sk from the ring. The secret key sk may be expressed as follows.

$$sk ← ( 1 , s ( x ) ) , s ( x ) ∈ R \qquad [ Mathematical Formula 4 ]$$

Here, s(x) denotes a randomly generated polynomial with a small coefficient. Because the secret key sk may include a polynomial of s, the secret key sk may be described as s in the present disclosure.

Also, the processor 230 calculates a first random polynomial a(x) from the ring. The first random polynomial a(x) may be expressed as follows.

$$a ( x ) ← R \qquad [ Mathematical Formula 5 ]$$

In addition, the processor 230 may calculate an error. Specifically, the processor 230 may extract an error from a discrete Gaussian distribution or a distribution of a statistical distance close thereto. Such an error may be expressed as follows.

$$e ( x ) ← {𝒟}_{α q}^{n} \qquad [ Mathematical Formula 6 ]$$

When the error is calculated, the processor 230 may calculate a second random polynomial by performing a modular operation on the error in the first random polynomial and the secret key. The second random polynomial may be expressed as follows.

$$b ( x ) = - a ( x ) s ( x ) + e ( x ) ( mod q ) \qquad [ Mathematical Formula 7 ]$$

Finally, a public key pk is set in a form including the first random polynomial and the second random polynomial as follows.

$$pk = ( b ( x ) , a ( x ) ) \qquad [ Mathematical Formula 8 ]$$

The above-described key generation method is only an example, but is not necessarily limited thereto, and a public key and a secret key may be generated using other methods.

According to various embodiments of the present disclosure, the processor 230 may generate a secret key in the form of a sparse secret key. The sparse secret key may be a secret key where most values are zero, and the number of non-zero valid data (i.e., −1 or +1) is extremely small. When the number of valid data is h, h may be set to a value having minimum safety with respect to a known attack method.

For example, a sparse secret key having a block structure may be used. Such a sparse secret key may be expressed as a block sparse secret key. The block sparse secret key may be a union of h index sets including consecutive index sets of a secret key. In this case, only one non-zero valid data may exist inside each index set. In addition, two index sets may not share one valid data. As a result, the total number of valid data of the block sparse secret key may be h.

Hereinafter, the secret key described in various embodiments of the present disclosure may be the block sparse secret key, but is not necessarily limited thereto.

For example, the sparse secret key may be configured such that i₁, i₂, . . . , iₕ-th indices are either 1 or −1, and each i is an element of a continuous interval

$${I}_{j} = [ \frac{jN}{h} , \frac{jN}{h} + w )$$

for some integer w and a union of all I₁, . . . , Iₕ satisfies {0, 1, . . . , N−1}. The sparse secret key may be expressed as s(X)=Σ_{0≤i<N}sᵢXⁱ.

As another example, the sparse secret key may be expressed as s(X)=Σ_{0≤i<N}sᵢXⁱ where the i₁, i₂, . . . , iₕ-th indices are either 1 or −1 for some h where h+1 is a power-of-two, and i₂_{^{k}}₍ₗ₊₎₋₁−i₂_{^{k}}₍ₗ₊₂₎₋₁ is an element of an interval [0, w) for all 1≤k≤log log (h+1) and 0≤l<2^{log log(h+1)-j}.

The processor 230 may generate other various keys. Specifically, in order for the server apparatus 100 to perform the SHIP bootstrapping described above, the processor 230 may generate various evaluation keys such as a relinearization key, a rotation key for slot movement, and a bootstrapping key, switching keys, etc. The bootstrapping keys may include a mode-raising key, a coefficient-to-slot (CtS) conversion key, a slot-to-coefficient (StC) conversion key, and other rotation keys.

Among the keys, the relinearization key (relinkey) and the rotation key (Rotation/Galois Keys) galoisKey may each be expressed in the following mathematical formula.

$$relinKey [ i ] = ( {a}_{i} , {b}_{i} = {a}_{i} s + {e}_{i} + {s}^{i} wi ) \qquad [ Mathematical Formula 9 ]$$

$${GaloisKey}_{gi} = ( {a}_{gi} , {b}_{gi} = - {a}_{gi} s + {e}_{gi} + {σ}_{g} ( s ) wi )$$

Here, σ_{g}(s) denotes a rotated secret key.

In addition, the processor 230 of the electronic apparatus 200 may generate the above-described first public key and second public key.

For example, the first public key may be a public key including, for all j=1, 2, . . . , h, given some parameter θ and when \vec{0}_{α} denotes a zero vector of length α and \vec{1}_{α} denotes a one vector of length α, for

$${j}^{′} = {i}_{j} mod \frac{N}{2} ,$$

for all

$$0 \leq {j}_{1} \leq ⌊ \frac{w - 1}{θ} ⌋ ,$$

a ciphertext M⁽⁰⁾(j)ⱼ_{₁} of

$${1}_{{j}_{1} = ⌈ {i}_{j} / θ ⌉} \cdot {Rot}_{- {i}_{j} mod θ} ( \frac{1 + {s}_{j}^{′}}{2} ( {\vec{0}}_{j}^{′} , {\vec{1}}_{\frac{N}{2} - j}^{′} ) ) ,$$

a ciphertext M⁽¹⁾(j)ⱼ_{₁} of

$${1}_{{j}_{1} = ⌈ {i}_{j} / θ ⌉} \cdot {Rot}_{- {i}_{j} mod θ} ( \frac{1 - {s}_{j}^{′}}{2} ( {\vec{0}}_{j}^{′} , {\vec{1}}_{\frac{N}{2} - j}^{′} ) ) ,$$

a ciphertext M⁽²⁾(j)ⱼ_{₁} of

$${1}_{{j}_{1} = ⌈ {i}_{j} / θ ⌉} \cdot {Rot}_{- {i}_{j} mod θ} ( \frac{1 + {s}_{j}^{′}}{2} ( {\vec{1}}_{j}^{′} , {\vec{0}}_{\frac{N}{2} - j}^{′} ) ) ,$$

and
a ciphertext M⁽³⁾(j)ⱼ_{₁} of

$${1}_{{j}_{1} = ⌈ {i}_{j} / θ ⌉} \cdot {Rot}_{- {i}_{j} mod θ} ( \frac{1 - {s}_{j}^{′}}{2} ( {\vec{1}}_{j}^{′} , {\vec{0}}_{\frac{N}{2} - j}^{′} ) ) .$$

In addition, the second public key may be a public key including, when iⱼ mod θ=Σ_{0≤k<┌log}_{_{B}} _{θ┐}jₖB^{k} for some B, ciphertexts of

$${1}_{{j}_{k} = ι} s ( {X}^{{5}^{ι \cdot {B}^{k}}} )$$

and 1ⱼ_{ₖ}₌ᵢ for all 0≤k<┌θ┐ and 0≤ι<B.

As another example, the first public key may be a public key including, for j=i₂_{^{k}}₍ₗ₊₁₎₋₁−i₂_{^{k}}₍ₗ₊₂₎₋₁, given some parameter θ and when \vec{0}_{α} denotes a zero vector of length α and \vec{1}_{α} denotes a one vector of length α, for

$${j}^{′} = j mod \frac{N}{2} ,$$

for all

$$0 \leq {j}_{1} \leq ⌊ \frac{w - 1}{θ} ⌋ ,$$

$${1}_{{j}_{1} = ⌈ j / θ ⌉} \cdot {Rot}_{- j mod θ} ( \frac{1 + {s}_{j}^{′}}{2} ( {\vec{0}}_{j}^{′} , {\vec{1}}_{\frac{N}{2} - j}^{′} ) ) {{M}^{( 0 )} ( j )}_{{j}_{1}}$$

a ciphertext M⁽⁰⁾(j)ⱼ_{₁} of

$${j}^{′} = j mod \frac{N}{2} 0 \leq {j}_{1} \leq ⌊ \frac{w - 1}{θ} ⌋ {1}_{{j}_{1} = ⌈ j / θ ⌉} \cdot {Rot}_{- j mod θ} ( \frac{1 + {s}_{j}^{′}}{2} ( {\vec{0}}_{j}^{′} , {\vec{1}}_{\frac{N}{2} - j}^{′} ) ) ,$$

a ciphertext M⁽¹⁾(j)ⱼ_{₁} of

$${1}_{{j}_{1} = ⌈ j / θ ⌉} \cdot {Rot}_{- j mod θ} ( \frac{1 + {s}_{j}^{′}}{2} ( {\vec{0}}_{j}^{′} , {\vec{1}}_{\frac{N}{2} - j}^{′} ) ) ,$$

a ciphertext M⁽²⁾(j)ⱼ_{₁} of

$${1}_{{j}_{1} = ⌈ j / θ ⌉} \cdot {Rot}_{- jmod θ} ( \frac{1 + {s}_{{j}^{′}}}{2} ( {\vec{1}}_{{j}^{′}} , {\vec{0}}_{\frac{N}{2} - {j}^{′}} ) ) ,$$

and
a ciphertext M⁽³⁾(j))ⱼ_{₁} of

$${1}_{{j}_{1} = ⌈ j / θ ⌉} \cdot {Rot}_{- jmod θ} ( \frac{1 - {s}_{{j}^{′}}}{2} ( {\vec{1}}_{{j}^{′}} , {\vec{0}}_{\frac{N}{2} - {j}^{′}} ) ) .$$

The processor 230 of the electronic apparatus 200 may store the generated keys in the memory 220. Thereafter, when a plaintext message to be homomorphically encrypted is identified, the processor 230 may perform homomorphic encryption on the plaintext message by using a public key and a secret key and generate a homomorphic ciphertext, and then transmit the homomorphic ciphertext, index information for designating valid data positions in a sparse secret key, and various keys to the server apparatus 100 through the communication interface 210.

For example, when the secret key s is generated in a polynomial such as s=s₀+s₁x+s₂x²+ . . . +sₙ₋₁xⁿ⁻¹, only some of coefficients s₀, s₁, s₂, . . . , sₙ₋₁ of the polynomial may be valid data such as −1, +1. Information indicating a term in which such valid data exists may be the index information.

As described above, when the electronic apparatus 200 converts a plaintext message into a homomorphic ciphertext by using a sparse secret key and a public key having a size equal to or less than a predetermined size and transmits the homomorphic ciphertext, the processor 130 of the server apparatus 100 receives the homomorphic ciphertext through the communication interface 110 and stores the homomorphic ciphertext in the memory 120.

While the homomorphic ciphertexts transmitted by electronic apparatuses are stored in the memory 120, the processor 130 may perform operations on the homomorphic ciphertexts when an event requiring operations occurs.

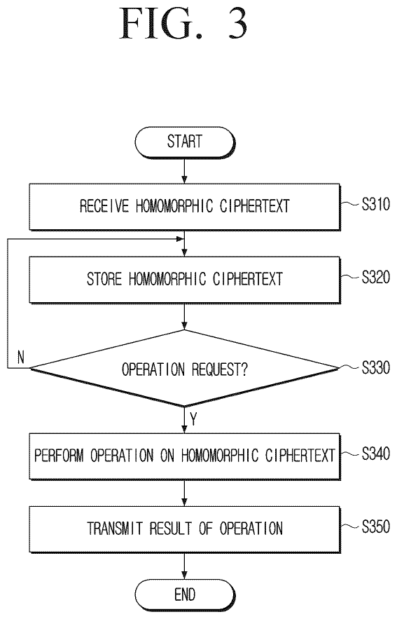

FIG. 3 is a flowchart illustrating a method of processing a homomorphic ciphertext in a server apparatus according to at least one embodiment of the present disclosure. The server apparatus of FIG. 3 may be implemented to have the same configuration as the server apparatus 100 disclosed in FIGS. 1 and 2.

Referring to FIG. 3, the server apparatus 100 receives and stores the homomorphic ciphertext (S310 and S320). In addition to the homomorphic ciphertext, the server apparatus 100 may store various pieces of related additional information together. For example, the server apparatus 100 may store first and second public keys, various evaluation keys, switching keys, etc.

In this state, when an operation request is received from a specific electronic apparatus (S330), the server apparatus 100 performs an operation on at least one of the stored homomorphic ciphertexts (S340). The type of operation may be variously changed according to operation request content. For example, an inner product operation may be performed on the stored homomorphic ciphertext and a query input by the electronic apparatus, but is not limited thereto.

Because the operation is performed in the homomorphic ciphertext state, a result of operation is also in the homomorphic ciphertext state. The server 100 transmits the result of operation as it is to the electronic apparatus (S350).

The electronic apparatus may decrypt the result of operation in the homomorphic ciphertext state by using a secret key. The decrypted result may be a result of operation of a plaintext message in the homomorphic ciphertext.

When a modulus level of the at least one homomorphic ciphertext stored in the memory 120 falls to a predetermined threshold level or lower, the processor 130 may perform a bootstrapping operation.

Specifically, the processor 130 may generate a plurality of partial ciphertexts based on valid terms corresponding to valid data positions in a sparse secret key among cyclical movement results of a plurality of coefficient vectors included in the at least one homomorphic ciphertext, and may combine the plurality of partial ciphertexts through a parallel binary product tree to reset the modulus level of the at least one homomorphic ciphertext.

For example, the processor 130 may generate a plurality of partial ciphertexts including two vectors

$${( exp exp ( - \frac{2 π i}{q} {\tilde{a}}_{j , k} ) )}_{0 \leq k < N / 2} and {( exp exp ( - \frac{2 π i}{q} {\tilde{a}}_{j , k} ) )}_{N / 2 \leq k < N} ,$$

for at least one homomorphic ciphertext

$$( b , a ) ∈ {R}_{q}^{2}$$

by using the first public key and the second public key when sⱼX^{j}·a=Σ_{0≤i<N}ã_{j,i}X^{j}, for all j=i₁, . . . , iₕ.

The processor 130 may combine the generated plurality of partial ciphertexts through a parallel binary product tree and performing matrix multiplication to obtain a ciphertext of as+b mod q, thereby resetting the modulus level of the at least one homomorphic ciphertext.

The public key having a size equal to or less than the predetermined size mentioned in various embodiments of the present disclosure may mean that a smaller public key is used compared to a public key used in a conventional SHIP method using a sparse secret key. In various embodiments of the present disclosure, as a smaller public key is used, bootstrapping may be more efficiently performed than the existing SHIP method. Accordingly, a bootstrapping operation according to various embodiments of the present disclosure may be referred to as a faster SHIP operation.

In other words, when bootstrapping is performed using the SHIP method, the server apparatus 100 performs an operation of performing a rotation operation to rotate a homomorphic ciphertext for each index of a sparse secret key and a MUX operation to select a rotated result, generating a plurality of partial ciphertexts, and then multiplying the plurality of partial ciphertexts together, and combining the plurality of partial ciphertexts through a product tree. To perform such an operation, the size of the public key increases because the public key includes various keys such as a public key for rotation, a public key for a partial operation, i.e., Half-Mux, an operation key for tree combination, etc.

However, according to various embodiments of the present disclosure, the size of the public key may be reduced compared to the existing SHIP method, and thus, the storage space consumption of the server apparatus 100 may be reduced, and the transmission cost through a network may also be reduced. In addition, sizes of auxiliary keys used for key-switching and relinearization operations in the server apparatuses are reduced, and thus, the overall bootstrapping speed may be faster.

When a homomorphic ciphertext is set to (a, b), and a sparse secret key is set to s, the bootstrapping of the processor 130 using the sparse secret key and the public key having a size equal to or less than the predetermined size may be expressed in the following mathematical formula.

$$exp ( 2 π {i [ as + b ]}_{0} / {Q}_{0} ) , exp ( 2 π {i [ as + b ]}_{1} / {Q}_{0} ) , … , exp ( 2 π {i [ as + b ]}_{n - 1} / {Q}_{0} ) = cos ( \frac{[ as + b ]}{{Q}_{0}} 2 π ) + i sin ( \frac{{[ as + b ]}_{0}}{{Q}_{0}} 2 π ) , … , cos ( \frac{{[ as + b ]}_{n - 1}}{{Q}_{0}} 2 π ) + i sin ( \frac{{[ as + b ]}_{n - 1}}{{Q}_{0}} 2 π ) = > \frac{1}{2 π} sin ( \frac{{[ as + b ]}_{0}}{{Q}_{0}} 2 π ) , … , \frac{1}{2 π} sin ( \frac{{[ as + b ]}_{n - 1}}{{Q}_{0}} 2 π ) ≃ \frac{{[ as + b ]}_{0}}{{Q}_{0}} , … , \frac{{[ as + b ]}_{n - 1}}{{Q}_{0}} \qquad [ Mathematical Formula 10 ]$$

In mathematical formula 10 above, Qo may be the last modulus level before performing the bootstrapping operation. Referring to mathematical formula 10, when the homomorphic ciphertext includes a linear equation such as as+b, it may be seen that the processor 130 performs a series of operations of converting the linear equation within the homomorphic ciphertext into a complex phase, then approximating the complex phase linearly using a sine function to restore a plaintext proportional value.

Meanwhile, according to at least one embodiment of the present disclosure, the electronic apparatus may share and use an identical mask of a plurality of homomorphic ciphertexts.

For example, when, for given 1≤j≤h, for each 0≤k<4, 0≤j₁<└w/θ┘, a first public key

$${{M}^{( k )} ( j )}_{{j}_{1}} = ( {a}^{( j )} , {b}_{k , {j}_{1}}^{( j )} )$$

encrypted under different secret keys sk_{k,j}_{₁} with an identical mask, and key-switching keys

$${ksk}_{k , {j}_{1}} = ( α , {β}_{k , {j}_{1}} )$$

that switch the secret key sk_{k,j}_{₁} with the identical mask to an existing secret key sk are transmitted from the electronic apparatus 200, the processor 130 of the server apparatus 100 may receive and store the first public key and the key-switching keys in the memory 120.

In this state, when it is necessary to perform bootstrapping on the homomorphic ciphertext of the corresponding electronic apparatus, the processor 130 performs a column method of the bootstrapping operation by applying the key-switching keys to the plurality of homomorphic ciphertexts transmitted from the electronic apparatus as

$${\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {{M}^{( k )} ( j )}_{{j}_{1}} = ( {a}^{( j )} , {\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {b}_{k , {j}_{1}}^{( j )} ) .$$

In addition, the processor 130 performs an operation of converting the secret key

$${\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {sk}_{k , {j}_{1}}$$

of the ciphertext by using the key-switching key

$$( α , {\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {β}_{k , {j}_{1}} )$$

for converting the secret key of the ciphertext into the existing secret key system of the server apparatus 100.

The processor 130 may perform various processing on the homomorphic ciphertext by using the converted secret key.

On the other hand, according to another embodiment of the present disclosure, the processor 130 may perform a conversion operation of reducing a ring degree with respect to the at least one homomorphic ciphertext, and may perform the bootstrapping operation on the homomorphic ciphertext based on the reduced ring degree.

For example, for a constant KIN, with respect to the sparse secret key s(X)=Σ_{0≤i<N/κ}sᵢxⁱ where i₁, i₂, . . . , iₕ-th indices are either 1 or −1, and each iⱼ is an element of a continuous interval

$${I}_{j} = [ \frac{jN}{h} , \frac{jN}{h} + w )$$

for some integer w and a union of all I₁, . . . , Iₕ satisfies {0, 1, . . . , N−1}, and the existing secret key sk=Σ_{0≤i<N}skᵢXⁱ, it is assumed that ciphertexts kskᵢ (0≤i<κ) of skⁱ(X)=Σ_{0≤j<N/κ}sk_{i+κj}(X) encrypted with s are transmitted from the electronic apparatus 100.

In this state, when a situation occurs where bootstrapping is required for at least one homomorphic ciphertext ct, the processor 130 may perform an operation

$${ct}_{i} = {κ}^{- 1} {\sum }_{0 \leq j < κ} {X}^{- \frac{2 ijN}{κ} - j} ct ( {X}^{\frac{2 iN}{κ} + 1} )$$

of reducing a ring degree from N to N/κ for the homomorphic ciphertext ct and switching a secret key from sk to s, and perform the bootstrapping operation on the homomorphic ciphertext based on the reduced ring degree.

This will be described in detail again in the following part.

Meanwhile, according to another embodiment of the present disclosure, at least some of public keys provided from the electronic apparatus 200 to the server apparatus 100 may be in a packed state.

For example, the second public key may be a public key configured to perform the blind rotation operation, for all j=1, 2, . . . , h, given some parameter θ, for some power-of-two k, on a ciphertext including a plurality of pieces of information of

$$ϵ = {k}^{- 1} {\sum }_{0 \leq j < k} {1}_{{j}_{1} = ⌊ \frac{{i}_{j}}{θ} ⌋} {X}^{\frac{{j}_{1} N}{k}} ,$$

and for all

$$0 \leq {j}_{1} \leq ⌊ \frac{w - 1}{θ} ⌋ ,$$

and on ciphertexts of

$${Rot}_{- {i}_{j} mod θ} ( \frac{1 + {s}_{{j}^{′}}}{2} ( {\vec{0}}_{{j}^{′}} , {\vec{1}}_{\frac{N}{2} - {j}^{′}} ) ) ,$$

$${Rot}_{- {i}_{j} mod θ} ( \frac{1 - {s}_{{j}^{′}}}{2} ( {\vec{0}}_{{j}^{′}} , {\vec{1}}_{\frac{N}{2} - {j}^{′}} ) ) ,$$

$${Rot}_{- {i}_{j} mod θ} ( \frac{1 + {s}_{{j}^{′}}}{2} ( {\vec{1}}_{{j}^{′}} , {\vec{0}}_{\frac{N}{2} - {j}^{′}} ) ) , and$$

$${Rot}_{- {i}_{j} mod θ} ( \frac{1 - {s}_{{j}^{′}}}{2} ( {\vec{1}}_{{j}^{′}} , {\vec{0}}_{\frac{N}{2} - {j}^{′}} ) ) .$$

In this case, the processor 130 may perform the column method by generating a ciphertext of

$${1}_{{j}_{1} = ⌊ {i}_{j} / θ ⌋} = {\sum }_{0 \leq i < k / 2} {X}^{- \frac{{j}_{1} N}{k} {5}^{i}} A u {t}_{{5}^{i}} ( ϵ ) + {\sum }_{0 \leq i < k / 2} {X}^{\frac{{j}_{1} N}{k} {5}^{i}} A u {t}_{- {5}^{i}} ( ϵ )$$

by using an automorphism homomorphic operation for each coefficient of the first public key for the column method, or by evaluating a linear operation obtained by combining the ciphertext and the column method as Σ_{0≤i<k/2}αᵢAut₅_{ⁱ}(ϵ)+'_{0≤i<k/2}βᵢAut₋₅_{ⁱ}(ϵ) or as Σ_{0≤i<k/2}Aut₅_{ⁱ}(Aut₋₅_{ⁱ}(αᵢ)ϵ)+Σ_{0≤i<k/2}Aut₋₅ⁱ(Aut₅_{ⁱ}(i)ϵ).

As another example, the second public key may include a ciphertext of jₖ for all 0≤k<┌log log θ┐ when j mod θ=Σ_{0≤k<<┌log θ┐}jₖ2^{k}.

In this case, the processor 130 may perform a column method to identify candidate indices for finding valid data positions in the sparse secret key, and perform a blind rotation operation to select the valid data positions among the candidate indices by using the second public key, relinearization key, and rotation key described above.
As another example, the second public key may include a ciphertext of

$${μ}_{j , k} = {B}^{- 1} \cdot {\sum }_{0 \leq ι < B} {1}_{{j}_{k} = ι} {X}^{\frac{ι N}{B}}$$

for a power-of-two B, when iⱼ mod θ=Σ_{0≤k<┌log}_{_{B}} θ┐jₖB^{k}, for all 0≤k<┌θ┐ and 0≤ι<B.
In this case, the processor 130 may perform the column method by using the first public key, and perform the blind rotation operation to select the valid data position among the candidate indices, by generating a ciphertext of

$${1}_{{j}_{k} = ι} = {\sum }_{0 \leq α < B} {X}^{- \frac{ια {N}^{2}}{{B}^{2}} ι N / B} {Aut}_{\frac{α N}{B} + 1} ( {μ}_{j , k} )$$

by using an automorphism homomorphic operation for each coefficient of the second public key, or by evaluating a linear operation obtained by combining the ciphertext and the blind rotation operation as

$${\sum }_{0 \leq ι < B} {Aut}_{{5}^{ι \cdot {2}^{k}}} ( ct ) \cdot {\sum }_{0 \leq α < B} {X}^{- \frac{ια {N}^{2}}{{B}^{2}} - \frac{ι N}{B}} \cdot {Aut}_{\frac{α N}{B} + 1} ( {μ}_{j , k} )$$

or as

$${\sum }_{0 \leq ι < B} {Aut}_{{5}^{ι \cdot {2}^{k}}} ( {μ}_{j , k} \cdot {\sum }_{0 \leq α < B} {X}^{- ι N / B} \cdot {Aut}_{- \frac{α N}{B} + {5}^{ι {B}^{k}}} ( {μ}_{j , k} ) ) .$$

As described above, the server apparatus 100 may efficiently perform the bootstrapping operation in various ways.

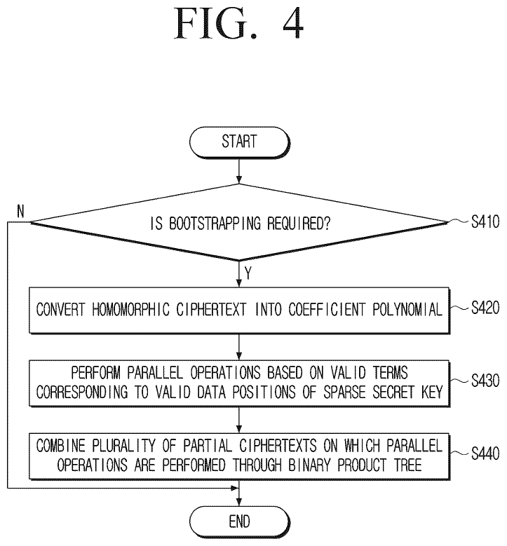

FIG. 4 is a flowchart illustrating a bootstrapping processing method of a server apparatus according to at least one embodiment of the present disclosure. The method of FIG. 4 may be performed by the server apparatus 100 having the configuration shown in FIG. 2, but is not necessarily limited thereto, and may be performed by an apparatus having a configuration different from that of FIG. 2 or with some components added or deleted.

Referring to FIG. 4, the server apparatus 100 determines whether bootstrapping is required (S410). Specifically, the processor 130 of the server apparatus 100 may identify a state requiring bootstrapping when the remaining modulus level among homomorphic ciphertexts pre-stored in the memory 120 falls to a predetermined threshold level or lower. The threshold level may be a modulus level at which no further operation is possible.

When it is determined that bootstrapping is necessary, the processor 130 converts a homomorphic ciphertext in the form of slot encoding into a coefficient polynomial (S420).

After performing parallel operations based on valid terms corresponding to valid data positions of a sparse secret key (S430), the processor 130 combines a plurality of partial ciphertexts on which parallel operations are performed through a binary product tree (S440), and performs bootstrapping.

Specifically, the processor 130 may rotate the converted coefficient polynomial by a specific amount to obtain cyclically shifted results, and perform a MUX operation that selects only valid terms corresponding to the valid data positions in the sparse secret key among the cyclically shifted results.

For example, the processor 130 may perform a HalfMuxRot operation. The HalfMuxRot operation refers to a SHIP operation that simultaneously performs a rotation operation that rotates a coefficient polynomial based on a specific index and a multiplexing operation, that is, a MUX operation, that selectively synthesizes valid terms among the rotated cyclically shifted results.

To perform the HalfMuxRot operation, the processor 130 uses a public key, a rotation key, a relinearization key, etc. among keys transmitted from the electronic apparatus 200.

The processor 130 may generate a plurality of valid partial ciphertexts by using the selected valid terms. The processor 130 may perform a bootstrapping operation of resetting the modulus level of at least one homomorphic ciphertext by combining the plurality of partial ciphertexts through the binary product tree.

Meanwhile, the server apparatus according to at least one embodiment of the present disclosure may perform bootstrapping by lowering a tree level. Specifically, the processor 130 may perform the bootstrapping operation by using, at least in part, a public key of the second-highest level lower than the top level in the binary product tree.

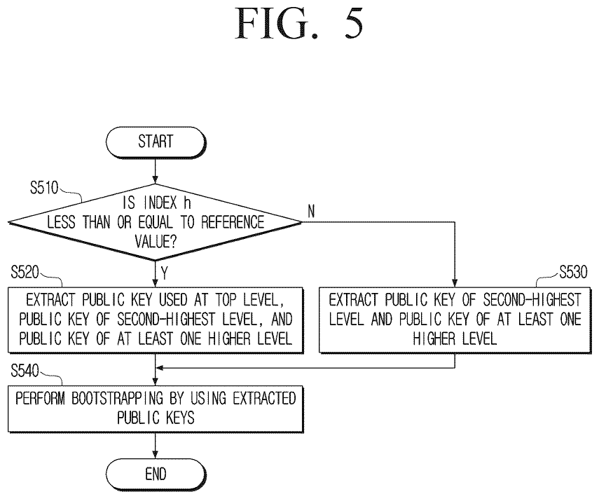

FIG. 5 is a flowchart illustrating a method of performing bootstrapping by lowering a tree level in a server apparatus according to at least one embodiment of the present disclosure.

According to FIG. 5, the processor 130 determines whether an index h is less than or equal to a reference value, and extracts and combines public keys of different tree levels according to a result of determination (S520 and S530).

Specifically, the processor 130 may perform a bootstrapping operation (S540) by jointly using a public key of the top level, a public key of the second-highest level, and a public key of at least one higher level below the second-highest level, for partial ciphertexts having indices that are less than a predetermined reference value among indices included in index information for designating the valid data positions in the sparse secret key (S520).

For example, when the total indices include i₀~iₙ, half (½) of public keys to be applied to partial ciphertexts having indices in the range i₀~i_{(h+1)/2)-1} that are less than a predetermined reference value (h+1)/2 use the public key of the top level (first level), and half (¼) of the other half use the public key of the second-highest level (second level). For the remaining half (¼), the public keys of the next ranking levels (third level, fourth level, etc.) are sequentially used in this way by half. The processor 130 may combine the public keys up to a level log(h+1).

On the other hand, the processor 130 may perform a bootstrapping operation by jointly using a public key of the second-highest level and a public key of the at least one higher level equal to or below the second-highest level, for partial ciphertexts having indices that are equal to or greater than the reference value among indices included in the index information for designating the valid data positions in the sparse secret key (S530).

As in the example described above, when the total indices include i₀~iₙ, half (½) of public keys to be applied to partial ciphertexts having indices in the range i₀~i_{(h+1)/2)-1} that are less than the predetermined reference value (h+1)/2 use the public key of the second-highest level (second level), and half (¼) of the other half use the public key of the next second-highest level (third level). For the remaining half (¼), the public keys of the next levels (fourth level, fifth level, etc.) are sequentially used in this way by half. In this way, the processor 130 may combine the public keys up to the level log(h+1).

In the case of the conventional SHIP bootstrapping method, numerous HalfMuxRot operations are performed at the top level, which increased the computational burden, resulting in delays. In the present embodiment, the HalfMuxRot operation is moved to a lower level of the product tree so that the operation may be performed at a smaller modulus.

Specifically, the processor 130 converts slot-encoded homomorphic ciphertexts into coefficient polynomials and then arranges the coefficient polynomials by using a column method. The column method is a method of arranging polynomial coefficients of homomorphic ciphertexts from a row structure to a column structure so that multiplication is possible in log(h) steps.

When there are h+1 homomorphic ciphertexts ctₒ and ct₁~ctₕ, the processor 130 may obtain one product P while arranging the homomorphic ciphertexts using the column method and then rotating and merging several ciphertexts selected from the homomorphic ciphertexts, ctᵢ, based on HalfMuxRot. This process may be expressed in the following algorithm.

$${ct}_{i}^{( 0 )} ← {HalfMuxRot}_{idx} \text{?} ( {ct}_{i} ) \qquad [ Mathematical Formula 11 ]$$

$${ct}_{h}^{( 0 )} ← {ω}_{1} ( b )$$

$$For j = 1 to log ( h + 1 ) do - For ℓ = 0 to {2}^{log ( h + 1 ) - j} - 1 do * {ct}_{ℓ}^{( j )} ← {ct}_{2 ℓ}^{( j - 1 )} \cdot {ct}_{2 ℓ + 1}^{( j - 1 )} .$$

$$\text{?} \text{indicates text missing or illegible when filed}$$

The product P obtained accordingly may be expressed in the following mathematical formula.

$$P = {{\prod }_{k = 0}}^{h} {HalfMuxRot}_{idx} \text{?} ( {ct}_{i} ) \text{?} \qquad [ Mathematical Formula 12 ]$$

$$\text{?} \text{indicates text missing or illegible when filed}$$

Mathematical formula 12 may be converted into and expressed in the following mathematical formula.

$$\text{?} \qquad [ Mathematical Formula 13 ]$$

$$\text{?} \text{indicates text missing or illegible when filed}$$

According to mathematical formula 13, the product P may be divided into two equal groups, each evaluated separately, then combined using a common HaltMuxRot_{idxh} for operation, thereby reducing the overall rotation cost. In the present embodiment, by dividing the product P into two equal groups for evaluation, several rotations may be performed at a lower level.

According to another embodiment of the present disclosure, the processor 130 may reconstruct a remaining modulus level of at least one homomorphic ciphertext as a product of available maximum primes so as to reduce the number of primes constituting the remaining modulus level.

In the case of conventional SHIP bootstrapping, there was a problem of large computational amount because modraising was performed with the entire high modulus. According to an embodiment of the present disclosure, the processor 130 may perform a ModSwitch operation of converting the entire modulus Q into a smaller set of moduli in the modraising step, and then, performing bootstrapping, and changing the smaller set of moduli back to the original modulus Q. The smaller set of moduli may include the product of available maximum primes.

In other words, when the remaining modulus level is configured as large prime numbers as possible, the number of primes constituting the modulus level is reduced, and as a result, the number of resale-mod-switch-NT operations required in the bootstrapping process is reduced, thereby accelerating the speed. Such an operation may be referred to as outsourced bootstrapping (OB).

Specifically, assuming that a modulus chain is Q=q₀ . . . qₜₒₚ, and that bootstrapping uses modulus such as q_{comp+1}, . . . , qₜₒₚ, the processor 130 constitutes a new modulus chain Q′ such as Q′=q′₀, . . . , q′ₖq_{comp+1}, . . . qₜₒₚ instead of performing moderasing with the entire modulus Q. Here, q′₀, . . . , q′ₖ are similar in the size to q₀, . . . , qₜₒₚ, but since each q′ᵢ is a large prime number of about dir 2⁶⁰, k value is generally smaller than top.

Bootstrapping is performed on Q′, which is the smaller set of moduli, and q′₀, . . . , q′ₖ are modswitched to q₀, . . . , qₜₒₚ in the final step, and thus, the original parameter set may be restored.

According to another embodiment of the present disclosure, the processor 130 may perform a grafting operation of dividing, merging, or rearranging a plurality of primes constituting a remaining modulus level of the at least one homomorphic ciphertext to convert a set of primes for constituting the remaining modulus level into a smaller set of primes composed of primes having larger sizes, and reconstruct the remaining modulus level as a product of the converted primes.

The grafting operation is an optimization technique that appropriately divides and merges a plurality of primes constituting a modulus level to generate the most efficient combination of prime numbers and sizes for bootstrapping. According to such a method, the number of primes is reduced, and thus, the bootstrapping speed may be improved.

Meanwhile, according to another embodiment of the present disclosure, when one electronic apparatus 200 transmits a plurality of homomorphic ciphertexts, an identical mask may be used in the plurality of homomorphic ciphertexts.

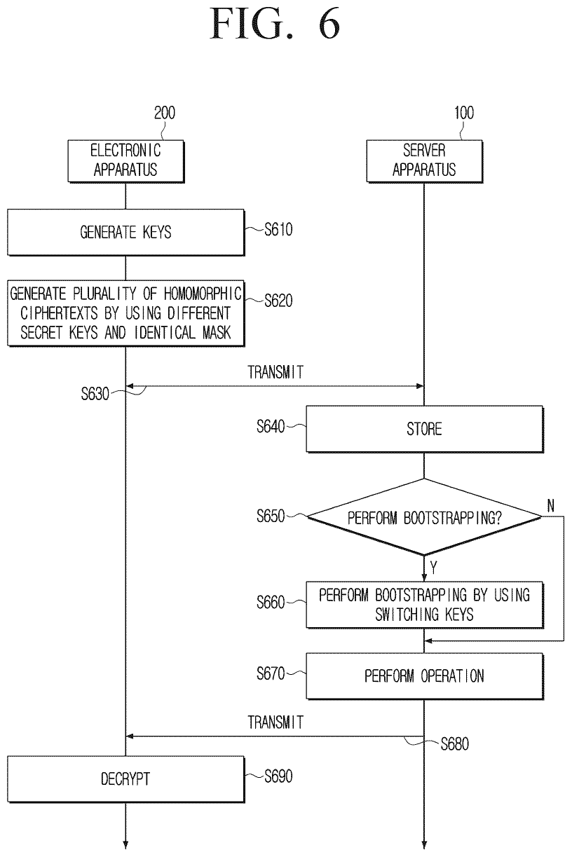

FIG. 6 is a flowchart illustrating a method of performing bootstrapping on a plurality of homomorphic ciphertexts having an identical mask in a server apparatus according to at least one embodiment of the present disclosure.

According to FIG. 6, the electronic apparatus 200 may generate a plurality of secret keys transformed into a switchable form and a switching key corresponding to each secret key (S610), and then generate a plurality of homomorphic ciphertexts corresponding to different secret keys and to which the identical mask, that is, a shared mask Shared-a, is applied (S620).

The electronic apparatus 200 may transmit the generated plurality of homomorphic ciphertexts, switching keys, etc. to the server apparatus 100 (S630). The switching key is a key for conversion into a secret key system of the server apparatus 100.

The processor 130 of the server apparatus 100 may receive the plurality of homomorphic ciphertexts and the switching key from the electronic apparatus and store the same in the memory 120 (S640).

In this state, when an event to perform bootstrapping occurs (S650), the processor 130 may perform a bootstrapping operation by applying the switching keys to the plurality of homomorphic ciphertexts (S660).

Specifically, for each non-zero index in a secret key in the above-described column method operation, the processor 130 may perform an operation based on the following mathematical formula.

$$∀ 0 \leq j < h , μ ∈ {ℂ}^{N / 2} : \\ BRotCM ( {cmkey}^{( j )} , μ ) := {\sum }_{i ∈ I} Ecd ( {Rot}_{u} ( μ ) ) \cdot {ε}_{i}^{( j )} \qquad [ Mathematical Formula 14 ]$$

In mathematical formula 14, εᵢ^{(j)} denotes a value obtained by encoding 1 when a j-th non-zero index of the secret key is equal to i+jN/h. In the present disclosure, for convenience of description, the index range I=[0, N/h−1] is used for all j.

Assuming that εᵢ^{(j)} is stored in the form of the shared mask Shared-a for a fixed j, εᵢ^{(j)} may be expressed in the following mathematical formula.

$$( {a}^{( j )} , {b}_{i}^{( j )} ) under the key {sk}_{i} \qquad [ Mathematical Formula 15 ]$$

$${a}^{( j )} {sk}_{i} + {b}_{i}^{( j )} = {ε}_{i}^{( j )} + {e}_{i}^{( j )}$$

Here, εᵢ(j) denotes a value encoded in a plaintext space, and eᵢ^{(j)} denotes noise.

In this case, mathematical formula 14 may be expressed as follows.

$$BRotCM ( {cmkey}^{( j )} , μ ) := {\sum }_{i ∈ I} Ecd ( {Rot}_{i} ( μ ) ) \cdot ( {a}^{( j )} , {b}_{i}^{( j )} ) = ( {α}^{( j )} , {β}^{( j )} ) . \qquad [ Mathematical Formula 16 ]$$

Mathematical formula 16 corresponds to a homomorphic ciphertext encrypted using the following key.

$${\sum }_{i ∈ I} {sk}_{i} Ecd ( {Rot}_{i} ( μ ) ) \qquad [ Mathematical Formula 17 ]$$

Therefore, the processor 130 only needs to evaluate part b in each branch of bootstrapping, and part a corresponding to the shared mask only needs to be evaluated once, and thus, the number of linear operations may be reduced, and as a result, the bootstrapping speed may be improved.

The processor 130 uses the following type of switching key SK for conversion into the secret key system of the server apparatus 100.

$$SK = ( a , a \cdot sk + P \cdot {\sum }_{i ∈ I} {sk}_{i} Ecd ( {Rot}_{i} ( μ ) ) + {ε}_{k} ) \qquad [ Mathematical Formula 18 ]$$

Finally, the processor 130 may rotate the j-th index by jN/h before moving to a HalfMuxRot step. Specifically, the processor 130 may perform rotation directly on each branch, or may rotate the switching key SK (modulus PQ/A) by jN/h for j=0 . . . h−1.

When bootstrapping is completed, the processor 130 may perform an operation requested by a user on the corresponding homomorphic ciphertext (S670), and then transmit a result of operation to the electronic apparatus 200 (S680).

The electronic apparatus 200 may decrypt the transmitted result of operation by using the secret key (S690).

On the other hand, according to another embodiment of the present disclosure, the processor 130 may perform a conversion operation of reducing a ring degree for at least one homomorphic ciphertext, and may perform a bootstrapping operation on the homomorphic ciphertext based on the reduced ring degree.

In other words, when bootstrapping is performed on an N degree ring in the conventional SHIP, a lot of operations are unnecessarily required, which slows down the speed. In the present embodiment, the degree of the ring may be reduced to N′=N/κ.

The processor 130 may reduce the ring degree N of the homomorphic ciphertext to N′=N/k. The homomorphic ciphertext with the reduced ring degree may be expressed in the following mathematical formula.

$${ct}_{i} = {κ}^{- 1} \cdot {\sum }_{j = 0}^{κ - 1} {X}^{- 2 ijN / κ - j} ct ( {X}^{2 iN / κ + 1} ) \qquad [ Mathematical Formula 19 ]$$

In mathematical formula 19, ct(X^{2iN/k+1}) denotes a homomorphic ciphertext before conversion.

According to this method, the depth of a MUX operation may be saved by log k.

According to another embodiment of the present disclosure, at least some of the public keys provided from the electronic apparatus 200 to the server apparatus 100 may be in a packed state.

Specifically, the public key received from the electronic apparatus 200 may include a first public key for a column method and a second public key for a blind rotation.

According to various embodiments of the present disclosure, the first public key may be a form in which a plurality of public keys are packed, or the second public key may be a form in which a plurality of public keys are packed, or both public keys may be in a packed form.

When the first public key is in a packed form, the processor 130 may identify candidate indices for finding valid data positions on a sparse secret key by using the first public key.

Specifically, the processor 130 may evaluate the following values for an index j and a mask mⱼ corresponding thereto in the column method.

$${\sum }_{{j}_{1} = 1}^{⌊ ( N - 1 ) / θ ⌋} {Rot}_{{j}_{1} θ} ( π ( a ) ) \cdot {1}_{{j}_{1} = ⌊ j / θ ⌋} \cdot {Rot}_{- {j}_{0}} ( {m}_{j} ) . \qquad [ Mathematical Formula 20 ]$$

According to an embodiment of the present disclosure, the electronic apparatus 200 packs 1_{ji=[j/θ]} values into one homomorphic ciphertext, and separately provides a ciphertext of a mask Rot.ⱼ₀(mⱼ).

For simplicity, assuming that k:=└(N−1)/θ┘ is a power of 2, given εᵢ=1_{i=└j/θ┘})1≤i≤k) as a selector, a polynomial.

$${k}^{- 1} \cdot \text{?} = {k}^{- 1} \cdot {\sum }_{i = 1}^{k} {\text{?}}_{i} {X}^{iN / k}$$

$$\text{?} \text{indicates text missing or illegible when filed}$$

may be encrypted into a single homomorphic ciphertext. Such an operation is referred to as packing.

In this regard, each εᵢ may be obtained by a linear combination of automorphisms with respect to ε. Therefore,

$${\sum }_{i = 1}^{k} {Rot}_{i θ} ( π ( a ) ) \cdot {ε}_{i}$$

may also be expressed again as the linear combination of automorphisms with respect to ε.

Specifically, the server device 100 may evaluate the following mathematical formula.

$${\sum }_{i = 1}^{k / 2} {α}_{i} \cdot {Aut}_{\text{?}} ( ε ) + {\sum }_{i = 1}^{k / 2} {β}_{i} \cdot {Aut}_{\text{?}} ( ε ) \qquad [ Mathematical Formula 21 ]$$

$$\text{?} \text{indicates text missing or illegible when filed}$$

To evaluate such a mathematical formula, a depth-optimal method or a computationally cheap method may be used.

On the other hand, an automorphism operation requires an additional auxiliary modulus. That is, the ciphertext of ε needs to be a homomorphic ciphertext having a large modulus, or d_num, which is the number of remaining moduli of the homomorphic ciphertext, needs to be 2 or more.

When d_num is only 1, a plaintext αᵢ ai may be pre-rotated, then plaintext-ciphertext multiplication may be performed, and rotation may be performed. Specifically, the server apparatus 100 may evaluate the following mathematical formula.

$${\sum }_{i = 1}^{k / 2} {Aut}_{\text{?}} ( {Aut}_{\text{?}} ( {α}_{i} ) \cdot ε ) + {\sum }_{i = 1}^{k / 2} {Aut}_{\text{?}} ( {Aut}_{\text{?}} ( {β}_{i} ) \cdot ε ) \qquad [ Mathematical Formula 22 ]$$

$$\text{?} \text{indicates text missing or illegible when filed}$$

Thereafter, the server apparatus 100 may multiply the output ciphertext by the ciphertext of the mask. On the other hand, when the server apparatus 100 performs only the column method (i.e., θ=1), the mask may be directly integrated into the plaintext and processed.

Meanwhile, according to another embodiment of the present disclosure, the server apparatus 100 may use a MUX key including a gadget ciphertext. Specifically, the processor 130 may perform a column method operation to identify candidate indices to find valid data positions within a sparse secret key and a blind rotation operation to select the valid data positions among the candidate indices by using the MUX key including the gadget encryption.

In the conventional SHIP bootstrapping method, two RGSW ciphertexts are provided for each layer of a MUX operation. In this case, because the number of rotations and layers increases, there is a problem that the size of the entire Mux key significantly increases.

According to the present embodiment, instead of providing two RGSW ciphertexts for each rotation, the server apparatus 100 separately provides a gadget ciphertext of a selector R and a key-switching key. Accordingly, the size of the Mux key may be reduced.

For example, assuming that a ciphertext

$${hmrkey}_{i} = ( a , b ) ∈ {R}_{PQ}^{2}$$

is provided for the selector R and a relinearization key rlk with respect to an i-th rotation, the input ciphertext ct may be blind-rotated as follows.

$${ct}^{′} = ( α , β ) ← {Rot}_{\text{?}} ( ct ) - ct \qquad [ Mathematical Formula 23 ]$$

$${ct}^{″} ← 〈 h ( 〈 h ( α ) , a 〉 ) , rlk 〉 + ( 〈 h ( α ) , b 〉 + 〈 h ( β ) , a 〉 , 〈 h ( β ) , b 〉 )$$

$$Return ct + {ct}^{″}$$

$$\text{?} \text{indicates text missing or illegible when filed}$$

Using this method allows the size of the Mux key to be reduced by half compared to the conventional method.

Meanwhile, according to another embodiment of the present disclosure, the second public key may be packed among the first public key for the column method and the second public key for blind rotation received from the electronic apparatus.

In this case, the processor 130 identifies candidate indices to find the valid data positions within the sparse secret key by using the first public key, and performs a blind rotation to select the valid data positions among the candidate indices by using the second public key.

Specifically, the server apparatus 100 may apply a technique for packing a plurality of selectors used in the Mux method into one homomorphic ciphertext. This is similar to packing in the column method, but unlike the column method, because all values used as inputs are ciphertexts, there is a difference in that additional linearization is required after addition.

For example, assuming that the input ciphertext ct is intended to rotate by a secret index i2^{k} for 0≤j<B, the server apparatus 100 may homomorphically evaluate the following mathematical formula.

$${\sum }_{\text{?}}^{\text{?}} {Rot}_{\text{?}} ( ct ) \cdot {1}_{\text{?}} = {\sum }_{\text{?}}^{\text{?}} {Aut}_{\text{?}} ( ct ) \cdot {1}_{\text{?}} \qquad [ Mathematical Formula 24 ]$$

$$\text{?} \text{indicates text missing or illegible when filed}$$

According to the conventional method, the electronic apparatus 200 has encrypted each B value μⱼ=1ⱼ₌₁ into B homomorphic ciphertexts. According to the present embodiment, the electronic apparatus 200 may pack into one polynomial expressed in the following mathematical formula.

$$μ = {B}^{- 1} \cdot {\sum }_{\text{?}}^{B - 1} {μ}_{j} {X}^{\text{?}} \qquad [ Mathematical Formula 25 ]$$

$$\text{?} \text{indicates text missing or illegible when filed}$$

The processor 130 of the server apparatus 100 may restore each selector j by performing partial eigen-sum by repeatedly applying a specific automorphism to such. The restored selectors may be expressed as follows.

$${μ}_{j} = {\sum }_{\text{?}}^{\text{?}} {Aut}_{\text{?}} ( {X}^{\text{?}} \cdot μ ) = {\sum }_{\text{?}}^{\text{?}} {X}^{\text{?}} \cdot {Aut}_{\text{?}} ( μ ) \qquad [ Mathematical Formula 26 ]$$

$$\text{?} \text{indicates text missing or illegible when filed}$$

The processor 130 of the server apparatus 100 may perform blind rotation on the homomorphic ciphertext by using the restored selector. A process of performing blind rotation may be expressed as follows.

$${\sum }_{\text{?}}^{\text{?}} {Aut}_{\text{?}} ( ct ) \cdot {\sum }_{\text{?}}^{\text{?}} {X}^{\text{?}} \cdot {Aut}_{\text{?}} ( μ ) \qquad [ Mathematical Formula 27 ]$$

$$\text{?} \text{indicates text missing or illegible when filed}$$

An auxiliary modulus may be required for the automorphism operation. Specifically, one prime for and one prime for automorphism may be required. In this case, the overall evaluation includes approximately 2B hoisted rotations and B ciphertext multiplications.

On the other hand, similar to the column method, a method of postponing the application of automorphism after multiplication is also possible. In this case, the mathematical formula is transformed as follows.

$${\sum }_{\text{?}}^{\text{?}} {Aut}_{\text{?}} ( μ \cdot {\sum }_{\text{?}}^{\text{?}} {X}^{\text{?}} \cdot Au \cdot ( ct ) ) \qquad [ Mathematical Formula 28 ]$$

$$\text{?} \text{indicates text missing or illegible when filed}$$

When using such transformed form, additional auxiliary primes may not be required.

According to another embodiment of the present disclosure, the server apparatus 100 may apply a structure for further improving computational parallelism in the process of performing blind rotation.

Conventionally, when only one non-zero index exists in a sparse secret key, one blind rotation is performed. This process includes one repetition of the column method and one repetition of the Mux method. Specifically, the existing blind rotation may be expressed in the following mathematical formula.

$${Rot}_{\text{?}} ( {\sum }_{\text{?}}^{\text{?}} {Rot}_{\text{?}} ( π ( a ) ) \cdot {1}_{\text{?}} \cdot {Rot}_{\text{?}} ( {m}_{j} ) ) \qquad [ Mathematical Formula 29 ]$$

$$\text{?} \text{indicates text missing or illegible when filed}$$

However, in an embodiment of the present disclosure, parallelization may be expanded by moving some summations inside the column method to the outside of the Mux operation. For example, when l is a divisor of. └(N−1)/θ┘ as follows, the processor 130 of the server apparatus 100 may perform blind rotation in parallel using the following mathematical formula.

$${\sum }_{\text{?}}^{\text{?}} {Rot}_{\text{?}} ( {\sum }_{\text{?}}^{\text{?}} {Rot}_{\text{?}} ( π ( a ) ) \cdot {1}_{\text{?}} \cdot {Rot}_{\text{?}} ( {m}_{\text{?}} ) ) \qquad [ Mathematical Formula 30 ]$$

$$\text{?} \text{indicates text missing or illegible when filed}$$

According to this embodiment, the public key size may be reduced.

As described above, according to various embodiments of the present disclosure, the server apparatus 100 may quickly and efficiently perform bootstrapping on the converted homomorphic ciphertext using a sparse secret key and a public key having a size equal to or less than a predetermined size.

Although various embodiments have been individually described in the above sections, each embodiment does not necessarily have to be implemented alone, and may be implemented in part or in whole in combination with at least one other embodiment.

In addition, the program for performing the various data processing methods described above may be distributed or used in a state stored on a non-transitory, readable storage medium. A non-transitory computer-readable medium refers to a medium that stores data semi-permanently and may be read by a device, rather than a medium that store data only for a short period, such as a register, cache, or memory. Specific examples of non-transitory computer-readable medium may include CD, DVD, hard disk, Blu-ray disc, USB, memory card, ROM, etc.

Although specific embodiments of the present disclosure are shown and described hereinabove, the present disclosure is not limited to the above-mentioned specific embodiments, and may be variously modified by those skilled in the art to which the present disclosure pertains without departing from the scope and spirit of the present disclosure as disclosed in the accompanying claims. These modifications should also be understood to fall within the scope and spirit of the present disclosure.

1. A server apparatus comprising:
a communication interface,
memory, and
a processor,
wherein the processor is configured to receive, from at least one electronic apparatus that converts a plaintext message into a homomorphic ciphertext by using a sparse secret key and a public key having a size equal to or less than a predetermined size, a first public key for performing a column method to identify candidate indices corresponding to valid data positions in the sparse secret key, a second public key for a blind rotation operation to select indices corresponding to the valid data positions among the candidate indices identified by the column method, and the homomorphic ciphertext, and store the first public key, the second public key, and the homomorphic ciphertexts in the memory, and
based on a modulus level of at least one homomorphic ciphertext stored in the memory falling to a predetermined threshold level or lower, perform a bootstrapping operation to reset the modulus level of the at least one homomorphic ciphertext, by generating a plurality of partial ciphertexts based on valid terms corresponding to the valid data positions in the sparse secret key by using the first public key and the second public key with respect to the at least one homomorphic ciphertext, and combining the plurality of partial ciphertexts through a parallel binary product tree and then performing matrix multiplication.

2. The server apparatus of claim 1, wherein
the sparse secret key is s(X)=Σ_{0≤i<N}sᵢXⁱ configured such that i₁, i₂, . . . , iₕ-th indices are either 1 or −1, and each iⱼ is an element of a continuous interval
$${I}_{j} = [ \frac{j N}{h} , \frac{j N}{h} + w )$$
for some integer w and a union of all I₁, . . . , Iₕ satisfies {0, 1, . . . , N−1},
the first public key is a public key including, for all j=1, 2, . . . , h, given some parameter θ and when \vec{0}_{α} denotes a zero vector of length α and \hat{1}_{α} denotes a one vector of length α, for
$${j}^{′} = {i}_{j} mod \frac{N}{2} ,$$
for all
$$0 \leq {j}_{1} \leq ⌊ \frac{w - 1}{θ} ⌋ ,$$
a ciphertext M⁽⁰⁾(j)ⱼ_{₁} of
$${1}_{{j}_{1} = ⌈ {i}_{j} / θ ⌉} \cdot {Rot}_{- {i}_{j} mod θ} ( \frac{1 + {s}_{{j}^{′}}}{2} ( {\vec{0}}_{{j}^{′}} , {\vec{1}}_{\frac{N}{2} - {j}^{′}} ) ) ,$$
a ciphertext M⁽¹⁾(j)ⱼ_{₁} of
$${1}_{{j}_{1} = ⌈ {i}_{j} / θ ⌉} \cdot {Rot}_{- {i}_{j} mod θ} ( \frac{1 - {s}_{{j}^{′}}}{2} ( {\vec{0}}_{{j}^{′}} , {\vec{1}}_{\frac{N}{2} - {j}^{′}} ) ) ,$$
a ciphertext M⁽²⁾(j)ⱼ_{₁} of
$${1}_{{j}_{1} = ⌈ {i}_{j} / θ ⌉} \cdot {Rot}_{- {i}_{j} mod θ} ( \frac{1 + {s}_{{j}^{′}}}{2} ( {\vec{1}}_{{j}^{′}} , {\vec{0}}_{\frac{N}{2} - {j}^{′}} ) ) ,$$
and
a ciphertext M⁽³⁾(j)ⱼ_{₁} of
$${1}_{{j}_{1} = ⌈ {i}_{j} / θ ⌉} \cdot {Rot}_{- {i}_{j} mod θ} ( \frac{1 - {s}_{{j}^{′}}}{2} ( {\vec{1}}_{{j}^{′}} , {\vec{0}}_{\frac{N}{2} - {j}^{′}} ) ) ,$$
the second public key is a public key including, when iⱼ mod θ=Σ_{0≤k<┌log}_{_{B}} θ┐jₖB^{k} for some B, ciphertexts of
$${1}_{{j}_{k} = ι} s ( {X}^{{5}^{ι \cdot {B}^{k}}} )$$
and 1ⱼ_{ₖ}_{=ι} for all 0≤k<┌log_{B} θ┐ and 0≤ι<B, and
the processor is configured to generate a plurality of partial ciphertexts, including two vectors
$${( exp ( - \frac{2 π i}{q} {\tilde{a}}_{j , k} ) )}_{0 \leq k < N / 2} and {( exp ( - \frac{2 π i}{q} {\tilde{a}}_{j , k} ) )}_{N / 2 \leq k < N} ,$$
for at least one homomorphic ciphertext
$$( b , a ) ∈ {R}_{q}^{2}$$
by using the first public key and the second public key when sⱼX^{j}·a=Σ_{0≤i<N}ã_{j,i}X^{j}, for all j=i₁, . . . , iₕ.

3. The server apparatus of claim 2, wherein
the sparse secret key is s(X)=Σ_{0≤i<N}sᵢXⁱ where the i₁, i₂, . . . , iₕ-th indices are either 1 or −1 for some h where h+1 is a power-of-two, and i₂_{^{k}}₍ₗ₊₁₎₋₁−l₂_{^{k}}₍ₗ₊₂₎₋₁ is an element of an interval [0, w) for all 1≤k<log (h+1) and 0≤l<2^{log(h+1)-j},
the first public key is a public key including, for j=i₂_{^{k(l+1)-1}}−i₂_{^{k(l+2)-1}}, given some parameter θ and when \vec{0}_{α} denotes a zero vector of length α and \vec{1}_{α} denotes a one vector of length α, for
$${j}^{′} = j mod \frac{N}{2} ,$$
for all
$$0 \leq {j}_{1} \leq ⌊ \frac{w - 1}{θ} ⌋ ,$$
$${1}_{{j}_{1} = ⌈ j / θ ⌉} \cdot {Rot}_{- j mod θ} ( \frac{1 + {s}_{{j}^{′}}}{2} ( {\vec{0}}_{{j}^{′}} , {\vec{1}}_{\frac{N}{2} - {j}^{′}} ) ) {{M}^{( 0 )} ( j )}_{{j}_{1}}$$
a ciphertext M⁽⁰⁾(j)ⱼ_{₁} of
$${j}^{′} = j mod \frac{N}{2} 0 \leq {j}_{1} \leq ⌊ \frac{w - 1}{θ} ⌋ {1}_{{j}_{1} = ⌈ j / θ ⌉} \cdot {Rot}_{- jmod θ} ( \frac{1 + {s}_{{j}^{′}}}{2} ( {\vec{0}}_{{j}^{′}} , {\vec{1}}_{\frac{N}{2} - {j}^{′}} ) ) ,$$
a ciphertext M⁽¹⁾(j)ⱼ_{₁} of
$${1}_{{j}_{1} = ⌈ j / θ ⌉} \cdot {Rot}_{- j mod θ} ( \frac{1 - {s}_{{j}^{′}}}{2} ( {\vec{0}}_{{j}^{′}} , {\vec{1}}_{\frac{N}{2} - {j}^{′}} ) ) ,$$
a ciphertext M^{(2)(j)}ⱼ_{₁} of
$${1}_{{j}_{1} = ⌈ j / θ ⌉} \cdot {Rot}_{- j mod θ} ( \frac{1 + {s}_{{j}^{′}}}{2} ( {\vec{1}}_{{j}^{′}} , {\vec{0}}_{\frac{N}{2} - {j}^{′}} ) ) ,$$
and
a ciphertext M^{(3)(j)}ⱼ_{₁} of
$${1}_{{j}_{1} = ⌈ j / θ ⌉} \cdot {Rot}_{- j mod θ} ( \frac{1 - {s}_{{j}^{′}}}{2} ( {\vec{1}}_{{j}^{′}} , {\vec{0}}_{\frac{N}{2} - {j}^{′}} ) ) ,$$
and
the processor is configured to perform the bootstrapping operation by using, at least in part, a public key used at the second-highest level lower than the top level in the binary product tree.

4. The server apparatus of claim 1, wherein the processor is configured to reconstruct a remaining modulus level of the at least one homomorphic ciphertext as a product of available maximum primes so as to reduce the number of primes constituting the remaining modulus level.

5. The server apparatus of claim 1, wherein the processor is configured to perform a grafting operation of dividing, merging, or rearranging a plurality of primes constituting a remaining modulus level of the at least one homomorphic ciphertext to convert a set of primes for constituting the remaining modulus level into a smaller set of primes composed of primes having larger sizes, and reconstruct the remaining modulus level as a product of the converted primes.

6. The server apparatus of claim 1, wherein the processor is configured to, for given 1≤j≤h, for each 0≤k<4, 0≤j₁<└w/θ┘, receive the first public key
$${{M}^{( k )} ( j )}_{{j}_{1}} = ( {a}^{( j )} , {b}_{k , {j}_{1}}^{( j )} )$$
encrypted under different secret keys sk_{k,j}_{₁} with an identical mask, and key-switching keys ksk_{k,j}_{₁}=(α, β_{k,j}_{₁}) that switch the secret keys sk_{k,j}_{₁} with the identical mask to an existing secret key sk from the electronic apparatus, store the first public key and the key-switching keys in the memory, perform the column method of the bootstrapping operation by applying the key-switching keys to the plurality of homomorphic ciphertexts as
$${\sum }_{{0 \leq k < 4}_{0 \leq {j}_{1} < ⌊ \frac{w}{θ} ⌋}} {pt}_{k} ( {X}^{{5}^{{j}_{1} θ}} ) {{M}^{( k )} ( j )}_{{j}_{1}} = ( {a}^{( j )} , {\sum }_{{0 \leq k < 4}_{0 \leq {j}_{1} < ⌊ \frac{w}{θ} ⌋}} {pt}_{k} ( {X}^{{5}^{{j}_{1} θ}} ) {b}_{k , {j}_{1}}^{( j )} ) ,$$
and then perform an operation of converting the secret key
$${\sum }_{{0 \leq k < 4}_{0 \leq {j}_{1} < ⌊ \frac{w}{θ} ⌋}} {pt}_{k} ( {X}^{{5}^{{j}_{1} θ}} ) {sk}_{k , {j}_{1}}$$
of the ciphertext by evaluating the key-switching key
$$( α , {\sum }_{{0 \leq k < 4}_{0 \leq {j}_{1} < ⌊ \frac{w}{θ} ⌋}} {pt}_{k} ( {X}^{{5}^{{j}_{1} θ}} ) {β}_{k , {j}_{1}} )$$
for converting the secret key of the ciphertext into an existing secret key system of the server apparatus.

7. The server apparatus of claim 1, wherein the processor is configured to, for a constant KIN, with respect to the sparse secret key s(X)=Σ_{0≤i<N}/κsᵢXⁱ where i₁, i₂, . . . , iₕ-th indices are either 1 or −1, and each iⱼ is an element of a continuous interval
$${I}_{j} = [ \frac{jN}{κ h} , \frac{jN}{κ h} + w )$$
for some integer w and a union of all I₁, . . . , Iₖ satisfies {0, 1, . . . , N/κ−1} and the existing secret key sk=Σ_{0≤i<N}skᵢXⁱ, receive ciphertexts kskᵢ (0≤i<κ) of skⁱ(X)=Σ_{0≤j<N/κ}sk_{i+κj}(X) encrypted with s from the electronic apparatus and store the ciphertexts in the memory, perform an operation
$${ct}_{i} = {κ}^{- 1} {\sum }_{0 \leq j < κ} {X}^{- \frac{2 ijN}{κ} - j} ct ( {X}^{\frac{2 iN}{κ} + 1} )$$
of reducing a ring degree from N to N/κ for the at least one homomorphic ciphertext ct and switching a secret key from sk to s, and perform the bootstrapping operation on the homomorphic ciphertext based on the reduced ring degree.

8. The server apparatus of claim 2, wherein the second public key is a public key configured to perform the blind rotation operation, for all j=1, 2, . . . , h, given some parameter θ, for some power-of-two k, on a packed ciphertext including a plurality of pieces of information of
$$ϵ = {k}^{- 1} {\sum }_{0 \leq {j}_{1} < k} {1}_{{j}_{1} = ⌊ \frac{{i}_{j}}{θ} ⌋} {X}^{\frac{{j}_{1} N}{k}} ,$$
and for all
$$0 \leq {j}_{1} \leq ⌊ \frac{w - 1}{θ} ⌋ ,$$
and on ciphertexts of
$${Rot}_{- {i}_{j} mod θ} ( \frac{1 + {s}_{{j}^{′}}}{2} ( {\vec{0}}_{{j}^{′}} , {\vec{1}}_{\frac{N}{2} - {j}^{′}} ) ) ,$$
$${Rot}_{- {i}_{j} mod θ} ( \frac{1 - {s}_{{j}^{′}}}{2} ( {\vec{0}}_{{j}^{′}} , {\vec{1}}_{\frac{N}{2} - {j}^{′}} ) ) ,$$
$${Rot}_{- {i}_{j} mod θ} ( \frac{1 + {s}_{{j}^{′}}}{2} ( {\vec{1}}_{{j}^{′}} , {\vec{0}}_{\frac{N}{2} - {j}^{′}} ) ) ,$$
$$and$$
$${Rot}_{- {i}_{j} mod θ} ( \frac{1 - {s}_{{j}^{′}}}{2} ( {\vec{1}}_{{j}^{′}} , {\vec{0}}_{\frac{N}{2} - {j}^{′}} ) ) ,$$
$$and$$
the processor is configured to perform the column method by generating a ciphertext of
$${1}_{{j}_{1} = ⌊ {i}_{j} / θ ⌋} = {\sum }_{0 \leq i < k / 2} {X}^{- \frac{{j}_{1} N}{k} {5}^{i}} {Aut}_{{5}^{i}} ( ϵ ) + {\sum }_{0 \leq i < k / 2} {X}^{\frac{{j}_{1} N}{k} {5}^{i}} {Aut}_{- {5}^{i}} ( ϵ )$$
by using an automorphism homomorphic operation for each coefficient of the first public key for the column method, or by evaluating a linear operation obtained by combining the ciphertext and the column method as Σ_{0≤i<k/2}αᵢAut₅_{ⁱ}(ϵ)+Σ_{0≤i<k/2}βᵢAut₋₅_{ⁱ}(ϵ) or as Σ_{0≤i<k/2}Aut₅_{ⁱ}(Aut₋₅_{ⁱ}(αᵢ)ϵ)+Σ_{0≤i<k/2}Aut₋₅_{ⁱ}(Aut₅_{ⁱ}(βᵢ)ϵ).

9. The server apparatus of claim 2, wherein
the second public key includes a ciphertext of jₖ for all 0≤k<┌log θ┐ when j mod θ=Σ_{0≤k<┌log θ┐}jₖ2^{k}, and
the processor is configured to perform the column method to identify candidate indices for finding the valid data positions in the sparse secret key, and perform a blind rotation operation to select the valid data positions among the candidate indices by using the second public key, a relinearization key, and a rotation key.

10. The server apparatus of claim 1, wherein
the second public key includes a ciphertext of
$${μ}_{j , k} = {B}^{- 1} \cdot {\sum }_{0 \leq ι < B} {1}_{{j}_{k} = ι} {X}^{\frac{ι N}{B}}$$
for a power-of-two B, when iⱼ mod θ=Σ_{0≤k<┌log}_{_{B}} θ┐ₖB^{k}, for all 0≤k<┌log_{B} θ┐ and 0≤ι<B, and
the processor is configured to perform the column method by using the first public key, and perform the blind rotation operation to select the valid data position among the candidate indices, by generating a ciphertext of
$${1}_{{j}_{k} = ι} = {\sum }_{0 \leq α < B} {X}^{- \frac{ια {N}^{2}}{{B}^{2}} - ι N / B} {Aut}_{\frac{α N}{B} + 1} ( {μ}_{j , k} )$$
by using an automorphism homomorphic operation for each coefficient of the second public key, or by evaluating a linear operation obtained by combining the ciphertext and the blind rotation operation as
$${\sum }_{0 \leq ι < B} {Aut}_{{{5}^{ι \cdot 2}}^{k}} ( ct ) \cdot {\sum }_{0 \leq α < B} {X}^{- \frac{ια {N}^{2}}{{B}^{2}} - \frac{ι N}{B}} \cdot {Aut}_{\frac{α N}{B} + 1} ( {μ}_{j , k} )$$
or as
$${\sum }_{0 \leq ι < B} {Aut}_{{{5}^{ι \cdot 2}}^{k}} ( {μ}_{j , k} \cdot {\sum }_{0 \leq α < B} {X}^{- ι N / B} \cdot {Aut}_{- \frac{α N}{B} + {5}^{ι {B}^{k}}} ( {μ}_{j , k} ) ) .$$

11. A method of processing homomorphic ciphertexts of a server apparatus, the method comprising:
receiving, from at least one electronic apparatus that converts a plaintext message into a homomorphic ciphertext by using a sparse secret key and a public key having a size equal to or less than a predetermined size, a first public key for performing a column method to identify candidate indices corresponding to valid data positions in the sparse secret key, a second public key for a blind rotation operation to select indices corresponding to the valid data positions among the candidate indices identified by the column method, and the homomorphic ciphertexts, and storing the first public key, the second public key, and the homomorphic ciphertexts, and
based on a modulus level of at least one homomorphic ciphertext stored in the memory falling to a predetermined threshold level or lower, performing a bootstrapping operation to reset the modulus level of the at least one homomorphic ciphertext,
wherein the performing of the bootstrapping operation comprises:
generating a plurality of partial ciphertexts based on valid terms corresponding to the valid data positions in the sparse secret key by using the first public key and the second public key with respect to the at least one homomorphic ciphertext; and
combining the plurality of partial ciphertexts through a parallel binary product tree and then performing matrix multiplication.

12. The method of claim 11, wherein
the sparse secret key is s(X)=Σ_{0≤i<N}sᵢXⁱ configured such that i₁, i₂, . . . , iₕ-th indices are either 1 or −1, and each iⱼ is an element of a continuous interval
$${I}_{j} = [ \frac{jN}{h} , \frac{jN}{h} + w )$$
for some integer w and a union of all I₁, . . . , Iₕ satisfies {0, 1, . . . , N−1},
the first public key is a public key including, for all j=1, 2, . . . , h, given some parameter θ and when \vec{0}_{α} denotes a zero vector of length α and \vec{1}ₐ denotes a one vector of length α, for
$${j}^{′} = {i}_{j} mod \frac{N}{2} ,$$
for all
$$0 \leq {j}_{1} \leq ⌊ \frac{w - 1}{θ} ⌋ ,$$
a ciphertext M⁽⁰⁾(j)ⱼ_{₁} of
$${1}_{{j}_{1} = ⌈ {i}_{j} / θ ⌉} \cdot {Rot}_{- {i}_{j} mod θ} ( \frac{1 + {s}_{{j}^{′}}}{2} ( {\vec{0}}_{{j}^{′}} , {\vec{1}}_{\frac{N}{2} - {j}^{′}} ) ) ,$$
a ciphertext M⁽¹⁾(j)ⱼ_{₁} of
$${1}_{{j}_{1} = ⌈ {i}_{j} / θ ⌉} \cdot {Rot}_{- {i}_{j} mod θ} ( \frac{1 - {s}_{{j}^{′}}}{2} ( {\vec{0}}_{{j}^{′}} , {\vec{1}}_{\frac{N}{2} - {j}^{′}} ) ) , ,$$
a ciphertext M⁽²⁾(j)ⱼ_{₁} of
$${1}_{{j}_{1} = ⌈ {i}_{j} / θ ⌉} \cdot {Rot}_{- {i}_{j} mod θ} ( \frac{1 + {s}_{{j}^{′}}}{2} ( {\vec{1}}_{{j}^{′}} , {\vec{0}}_{\frac{N}{2} - {j}^{′}} ) ) ,$$
and
a ciphertext M⁽³⁾(j)ⱼ_{₁} of
$${1}_{{j}_{1} = ⌈ {i}_{j} / θ ⌉} \cdot {Rot}_{- {i}_{j} mod θ} ( \frac{1 - {s}_{{j}^{′}}}{2} ( {\vec{1}}_{{j}^{′}} , {\vec{0}}_{\frac{N}{2} - {j}^{′}} ) ) ,$$
the second public key is a public key including, when i mod θ=Σ_{0≤k<┌log}_{_{B}} _{θ┐}jₖB^{k} for some B, ciphertexts of
$${1}_{{j}_{k} = ι} s ( {X}^{{5}^{ι \cdot {B}^{k}}} )$$
and 1ⱼ_{ₖ}_{=ι} for all 0<k<┌log_{B} θ┐ and 0≤ι<B, and
the performing of the bootstrapping operation comprises:
generating a plurality of partial ciphertexts including two vectors
$${( exp ( - \frac{2 π i}{q} {\tilde{a}}_{j , k} ) )}_{0 \leq k < N / 2} and {( exp ( - \frac{2 π i}{q} {\tilde{a}}_{j , k} ) )}_{N / 2 \leq k < N} ,$$
for at least one homomorphic ciphertext
$$( b , a ) ∈ {R}_{q}^{2}$$
by using the first public key and the second public key when sⱼX^{j}·a=Σ_{0≤i<N}ã_{j,i}X^{j}, for all j=i₁, . . . , iₕ.

13. The method of claim 12, wherein
the sparse secret key is s(X)=Σ_{0≤i<N}sᵢXⁱ where the i₁, i₂, . . . , iₕ-th indices are either 1 or −1 for some h where h+1 is a power-of-two, and i₂_{^{k}}₍ₗ₊₁₎₋₁−l₂_{^{k}}₍ₗ₊₂₎₋₁ is an element of an interval [0, w) for all 1≤k≤log (h+1) and 0≤l<2^{log(h+1)-j},
the first public key is a public key including, for j=i₂_{^{k}}₍ₗ₊₎₋₁−i₂_{^{k}}₍ₗ₊₂₎₋₁, given some parameter θ and when \vec{0}_{α} denotes a zero vector of length α and \vec{1}_{α} denotes a one vector of length α, for
$${j}^{′} = j mod \frac{N}{2} ,$$
for all
$$0 \leq {j}_{1} \leq ⌊ \frac{w - 1}{θ} ⌋ ,$$
$${1}_{{j}_{1} = ⌈ j / θ ⌉} \cdot {Rot}_{- j mod θ} ( \frac{1 + {s}_{{j}^{′}}}{2} ( {\vec{0}}_{{j}^{′}} , {\vec{1}}_{\frac{N}{2} - {j}^{′}} ) ) {{M}^{( 0 )} ( i )}_{{j}_{1}}$$
a ciphertext M⁽⁰⁾(j)ⱼ_{₁} of
$${j}^{′} = j mod \frac{N}{2} 0 \leq {j}_{1} \leq ⌊ \frac{w - 1}{θ} ⌋ {1}_{{j}_{1} = ⌈ j / θ ⌉} \cdot {Rot}_{- j mod θ} ( \frac{1 + {s}_{{j}^{′}}}{2} ( {\vec{0}}_{{j}^{′}} , {\vec{1}}_{\frac{N}{2} - {j}^{′}} ) ) ,$$
a ciphertext M⁽¹⁾(j)ⱼ_{₁} of
$${1}_{{j}_{1} = ⌈ j / θ ⌉} \cdot {Rot}_{- j mod θ} ( \frac{1 - {s}_{{j}^{′}}}{2} ( {\vec{0}}_{{j}^{′}} , {\vec{1}}_{\frac{N}{2} - {j}^{′}} ) ) ,$$
a ciphertext M⁽²⁾(j)ⱼ_{₁} of
$${1}_{{j}_{1} = ⌈ j / θ ⌉} \cdot {Rot}_{- j mod θ} ( \frac{1 + {s}_{{j}^{′}}}{2} ( {\vec{1}}_{{j}^{′}} , {\vec{0}}_{\frac{N}{2} - {j}^{′}} ) ) ,$$
and
a ciphertext M⁽³⁾(j)ⱼ_{₁} of
$${1}_{{j}_{1} = ⌈ j / θ ⌉} \cdot {Rot}_{- j mod θ} ( \frac{1 - {s}_{{j}^{′}}}{2} ( {\vec{1}}_{{j}^{′}} , {\vec{0}}_{\frac{N}{2} - {j}^{′}} ) ) ,$$
and
the performing of the bootstrapping operation comprises:
performing the bootstrapping operation by using, at least in part, a public key used at the second-highest level lower than the top level in the binary product tree.

14. The method of claim 11, wherein the performing of the bootstrapping operation comprises: reconstructing a remaining modulus level of the at least one homomorphic ciphertext as a product of available maximum primes so as to reduce the number of primes constituting the remaining modulus level.

15. The method of claim 11, wherein the performing of the bootstrapping operation comprises:
performing a grafting operation of dividing, merging, or rearranging a plurality of primes constituting a remaining modulus level of the at least one homomorphic ciphertext to convert a set of primes for constituting the remaining modulus level into a smaller set of primes composed of primes having larger sizes; and
reconstructing the remaining modulus level as a product of the converted primes.

16. The method of claim 11, wherein
the storing comprises: for given 1≤j≤h, for each 0≤k<4, 0≤j₁<└w/θ┘, receiving the first public key
$${{M}^{( k )} ( j )}_{{j}_{1}} = ( {a}^{( j )} , {b}_{k , {j}_{1}}^{( j )} )$$
encrypted under different secret keys sk_{k,j}_{₁} with an identical mask, and key-switching keys ksk_{k,j}_{₁}=(α,β_{k,j}_{₁}) that switch the secret keys sk_{k,j}_{₁} with the identical mask to an existing secret key sk from the electronic apparatus and storing the first public key and the key-switching keys, and
the performing of the bootstrapping operation comprises:
performing the column method of the bootstrapping operation by applying the key-switching keys to the plurality of homomorphic ciphertexts as
$${\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {{M}^{( k )} ( j )}_{{j}_{1}} = ( {a}^{( j )} , {\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {b}_{k , {j}_{1}}^{( j )} ) ,$$
and then performing an operation of converting the secret key
$${\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {sk}_{k , {j}_{1}}$$
of the ciphertext by evaluating the key-switching keys
$$( α , {\sum }_{\begin{matrix}0 \leq k < 4 \\ 0 \leq {j}_{1} < ⌊ \frac{w}{θ} ⌋\end{matrix}} {pt}_{k} ( {X}^{{5}^{{j}_{1} θ}} ) {β}_{k , {j}_{1}} )$$
for converting the secret key of the ciphertext into an existing secret key system of the server apparatus.

17. The method of claim 11, wherein
the storing comprises: for a constant KIN, with respect to the sparse secret key s(X)=Σ_{0≤i<N/κ}sᵢXⁱ where i₁, i₂, . . . , iₕ-th indices are either 1 or −1, and each iⱼ is an element of a continuous interval
$${I}_{j} = [ \frac{jN}{κ h} , \frac{jN}{κ h} + w )$$
for some integer w and a union of all I₁, . . . , Iₕ satisfies {0, 1, . . . , N/κ−1}, and the existing secret key sk=Σ_{0≤i<N}skᵢXⁱ, receiving ciphertexts kskᵢ (0≤i<κ) of skⁱ(X)=Σ_{0≤j<N/κ}sk_{i+κj}(X) encrypted with s from the electronic apparatus and storing the ciphertexts, and
the performing of the bootstrapping operation comprises:
performing an operation
$${ct}_{i} = {κ}^{- 1} {\sum }_{0 \leq j < κ} {X}^{- \frac{2 ijN}{κ} - j} ct ( {X}^{\frac{2 iN}{κ} + 1} )$$
of reducing a ring degree from N to N/κ for the at least one homomorphic ciphertext ct and switching a secret key from sk to s; and
performing the bootstrapping operation on the homomorphic ciphertext based on the reduced ring degree.

18. The method of claim 12, wherein the second public key is a public key configured to perform the blind rotation operation, for all j=1, 2, . . . , h, given some parameter θ, for some power-of-two k, on a packed ciphertext including a plurality of pieces of information of
$$ϵ = {k}^{- 1} {\sum }_{0 \leq {j}_{1} < k} {1}_{{j}_{1} = ⌊ \frac{{i}_{j}}{θ} ⌋} {X}^{\frac{{j}_{1} N}{k}} ,$$
and for all
$$0 \leq {j}_{1} \leq ⌊ \frac{w - 1}{θ} ⌋ ,$$
and on ciphertexts of
$${Rot}_{- {i}_{j} mod θ} ( \frac{1 + {s}_{{j}^{′}}}{2} ( {\vec{0}}_{{j}^{′}} , {\vec{1}}_{\frac{N}{2} - {j}^{′}} ) ) ,$$
$${Rot}_{- {i}_{j} mod θ} ( \frac{1 - {s}_{{j}^{′}}}{2} ( {\vec{0}}_{{j}^{′}} , {\vec{1}}_{\frac{N}{2} - {j}^{′}} ) ) ,$$
$${Rot}_{- {i}_{j} mod θ} ( \frac{1 + {s}_{{j}^{′}}}{2} ( {\vec{1}}_{{j}^{′}} , {\vec{0}}_{\frac{N}{2} - {j}^{′}} ) ) , and$$
$${Rot}_{- {i}_{j} mod θ} ( \frac{1 - {s}_{{j}^{′}}}{2} ( {\vec{1}}_{{j}^{′}} , {\vec{0}}_{\frac{N}{2} - {j}^{′}} ) ) , and$$
the performing of the bootstrapping operation comprises: performing the column method by generating a ciphertext of
$${1}_{{j}_{1} = ⌊ {i}_{j} / θ ⌋} = {\sum }_{0 \leq i < k / 2} {X}^{- \frac{{j}_{1} N}{k} {5}^{i}} {Aut}_{{5}^{i}} ( ϵ ) + {\sum }_{0 \leq i < k / 2} {X}^{\frac{{j}_{1} N}{k} {5}^{i}} {Aut}_{- {5}^{i}} ( ϵ )$$
by using an automorphism homomorphic operation for each coefficient of the first public key for the column method, or by evaluating a linear operation obtained by combining the ciphertext and the column method as Σ_{0≤i<k/2}αᵢAut₅_{ⁱ}(ϵ)+Σ_{0≤i<k/2}βᵢAut₋₅_{ⁱ}(ϵ) or as Σ_{≤i<k/2}Aut₅_{ⁱ}(Aut₋₅_{ⁱ}(αᵢ)ϵ)+Σ_{0≤i<k/2}Aut₋₅_{ⁱ}(Aut₅_{ⁱ}(βᵢ)ϵ).

19. The method of claim 12, wherein
the second public key includes a ciphertext of jₖ for all 0≤k<┌log θ┐ when j mod θ=Σ_{0≤k<┌log θ┐}jₖ2^{k}, and
the performing of the bootstrapping operation comprises:
performing the column method to identify candidate indices for finding the valid data positions in the sparse secret key; and
performing a blind rotation operation to select the valid data positions among the candidate indices by using the second public key, a relinearization key, and a rotation key.

20. The method of claim 11, wherein
the second public key includes a ciphertext of
$${μ}_{j , k} = {B}^{- 1} \cdot {\sum }_{0 \leq ι < B} {1}_{{j}_{k} = ι} {X}^{\frac{ι N}{B}}$$
for a power-of-two B, when iⱼ mod θ=Σ_{0≤k<┌log}_{_{B}} _{θ┐}jₖB^{k}, for all 0≤k<┌log_{B} θ┘ and 0≤ι<B, and
the performing of the bootstrapping operation comprises:
performing the column method by using the first public key; and
performing the blind rotation operation to select the valid data position among the candidate indices, by generating a ciphertext of
$${1}_{{j}_{k} = ι} = {\sum }_{0 \leq α < B} {X}^{- \frac{ια {N}^{2}}{{B}^{2}} - ι N / B} {Aut}_{\frac{α N}{B} + 1} ( {μ}_{j , k} )$$
by using an automorphism homomorphic operation for each coefficient of the second public key, or by evaluating a linear operation obtained by combining the ciphertext and the blind rotation operation as
$${\sum }_{0 \leq ι < B} {Aut}_{{5}^{ι \cdot {2}^{k}}} ( ct ) \cdot {\sum }_{0 \leq α < B} {X}^{- \frac{ια {N}^{2}}{{B}^{2}} - \frac{ι N}{B}} \cdot {Aut}_{\frac{α N}{B} + 1} ( {μ}_{j , k} )$$
or as
$${\sum }_{0 \leq ι < B} {Aut}_{{5}^{ι \cdot {2}^{k}}} ( {μ}_{j , k} \cdot {\sum }_{0 \leq α < B} {X}^{- ι N / B} \cdot {Aut}_{- \frac{α N}{B} + {5}^{ι {B}^{k}}} ( {μ}_{j , k} ) ) .$$
